(19) United States
(12) Patent Application Publication
(10) Pub. No.: US 2007/0055568 A1
(43) Pub. Date: Mar. 8, 2007

(54) ONLINE REAL-TIME PRICE DISCOUNTING SYSTEM AND METHOD

(76) Inventor: GARY THOMAS OSBORNE, Indianapolis, IN (US)

Correspondence Address: BOSE MCKINNEY & EVANS LLP;JAMES COLES, 135 N PENNSYLVANIA ST, SUITE 2700, INDIANAPOLIS, IN, 46204, US

(21) Appl. No.: 11/470,402

(22) Filed: Sep. 6, 2006

Related U.S. Application Data
(60) Provisional application No. 60/714,447, filed on Sep. 6, 2005.
(60) Provisional application No. 60/808,395, filed on May 25, 2006.

(51) Int. Cl. G06Q 30/00

(52) U.S. Cl. 705/14

(57) ABSTRACT

An on-line price discounting system and method that enables a host retailer to sell an item at different prices to different buyers, the method comprising offering the item for sale on a host site, the item having a host item description and a host offering price; providing a buyer with an option of lowering the host offering price based on information for the item from a competitor site; accepting buyer-provided information regarding the item from the competitor site; calculating a discount price for the item using the buyer-provided information; presenting the buyer with the discount price for the item; and enabling the buyer to place an order for the item at the discount price. The method can include steps for reviewing and approving the buyer order. The method can include steps for making requests from the host website to the competitor website not appear to originate from the host website.

### CROSS-REFERENCE TO RELATED APPLICATIONS

This application claims the benefit of U.S. Provisional Application Ser. No. 60/714,447, filed on Sep. 6, 2005, entitled “Online Real-Time Price Discounting System and Method,” and U.S. Provisional Application Ser. No. 60/808,395, filed on May 25, 2006, entitled “Online Real-Time Price Discounting System and Method,” both of which are incorporated herein by reference.

### FIELD OF THE INVENTION

The present invention relates generally to electronic commerce over a network, such as the Internet, for items offered for sale on multiple web sites. More particularly, the invention relates to a system and associated method for enabling a retailer to give a buyer an option to try to discount the retailer's price based on the price offered by competitors.

### BACKGROUND

Online internet retailers need to adjust prices of their products and services (items) in order to be competitive with other retailers selling the same items. Given two retailers (host and competitor) each selling the same item, the one selling that item for less is more likely to sell more items.

Retailers are keenly aware of this. As a result, they browse each others' websites in order to learn what prices items are being sold for. For example, when the host retailer discovers that a competitor is selling the item for $10.00, the host retailer could change its price to $9.99. Later, the competitor discovers the price change at the host retailer's website and changes its price to $9.98. Then the host retailer later discovers the lower price that the competitor has and lowers its price to $9.97; and so on and so on.

These price reductions are a so-called “race to the bottom” or simply a “race”. In other words, back-and-forth price discounts decrease the profits of both the host and competitor retailers until an equilibrium is reached where neither can decrease prices further without loosing money.

The race to the bottom helps buyers save money at the expense of both retailers who lose profits. Luckily for the retailers, the race is not always a race. Some buyers don't care to check different retailers to find lower prices—especially for low cost items where any potential savings could not offset the buyer's time and effort finding lower prices.

So, some retailers choose not to participate in the race. They sell at higher prices. But those retailers lose sales to lower price competitors who do participate in the race. Whether to participate in the race or not is a dilemma facing every retailer who sells into a competitive market. There are two questions that retailers struggle to answer: “Would I earn more profit by dropping my price to increase sales volume?” and “Would I earn more by raising my price to make more profit on each sale?” Retailers have tried to find a balance between these opposing views with limited success.

The present invention resolves this long-standing dilemma by changing the choice of participation in the race from the retailers to the buyers and in doing so, both groups benefit. It enables the retailers to discount prices when selling to buyers who care about low prices; and not discount prices when selling to buyers who do not care about lower prices. The retailer can make some sales at higher prices (for higher profits) and other sales at lower prices (for more sales volume) depending on the buyers' preferences. Buyers can save money by having the retailers participate in the race, or save time by choosing not to have the retailers participate in the race.

### SUMMARY

Embodiments of the present invention include an on-line price discounting system and method that enables a host retailer to sell an item at different prices to different buyers. The system includes a host webpage that offers the item for sale at a host offering price and that has a host item description; a price discounting option that enables a buyer to attempt to lower the host offering price based on information for the item from a competitor site; a data collection module that collects buyer-provided information regarding the item from the competitor site; a discount price calculation module that calculates a discount price for the item using the buyer-provided information; and a host webpage revision module that offers the item for sale at the discount price.

The data collection module can include a data collection page with one or more fields for entry of the buyer-provided information. In some embodiments, the data collection page can include fields for entry of a buyer-entered price or a competitor item webpage address. The data collection page can also include an embedded web browser to enable the buyer to navigate the embedded web browser to a competitor item page. The data collection page can include functionality to compare the buyer-entered price to a competitor price, and take a non-approval action if the buyer-entered price does not equal the competitor price.

The system can also include a discount database containing a plurality of discount records, each discount record being for a unique buyer, and the host webpage revision module can include functionality to search the discount database for a buyer discount record for the buyer and create a buyer discount record for the buyer if none is found, and store the host item code and the discount price in the buyer discount record. This can enable the system, whenever a current item price for the item is presented to the buyer, to check the discount database for a stored discount record for the buyer, the stored discount record containing a stored item code and a stored discount price, and if a matching record is found to retrieve the stored discount price for the host item code; and present the stored discount price for the host item code as the current item price for the buyer.

The system can also include a price approval module that retrieves a competitor item description and a competitor price using buyer-entered competitor information; checks whether the competitor item description and the host item description describe the same items; checks whether the buyer-entered price and the competitor price are equal; and, when the competitor and host item descriptions describe the same items and the buyer-entered price and the competitor price are equal, approves the buyer order.

The discount price calculation module can include functionality to calculate the discount price using discount parameters stored in an administrative discount setup record. The discount price calculation module can include the functionality to calculate a temporary price less than or equal to the competitor price; calculate a minimum price based on the discount parameters; set the temporary price equal to the minimum price when the minimum price is greater than the temporary price; and set the discount price equal to the lesser of the temporary price and the host offering price. The discount price calculation module can also include functionality to calculate a shipping cost difference, and incorporate the shipping cost difference in the discount price calculation for the item. Alternatively, the discount price calculation module can include functionality to calculate an additional discount to be deducted from the host offering price, such that the discount price is equal to the host offering price minus the additional discount; and the buyer can be presented with the additional discount. The additional discount can be offered as cash, a cash equivalent or a non-cash equivalent.

The system can also include an arrangement that makes requests from the host site for information on a competitor site not appear to originate from the host site. In one embodiment, the arrangement includes a relay on a buyer computer such that requests from the host site for requested information on the competitor site are sent to the relay, and the requested information on the competitor site is received from the relay. In another embodiment, the arrangement includes a relay installed on a relay computer such that requests from the host site for requested information on the competitor site are sent to the relay, and the requested information on the competitor site is received from the relay. In yet another embodiment, the arrangement includes a dynamic network connection at the host site having a dynamic IP address such that requests from the host site for requested information on the competitor site are sent through the dynamic network connection; and the requested information on the competitor site is received through the dynamic network connection.

Additional embodiments, aspects, and advantages of the present invention will be apparent from the following description.

### BRIEF DESCRIPTION OF THE FIGURES

FIG. 1 is a schematic illustration of an exemplary environment for an embodiment of the present invention that includes a host webserver, a competitor webserver and a buyer computer connected through a network;

FIG. 2 is a flow diagram showing an embodiment of an ordering method;

FIG. 3 is an example browser display of a host retailer item page;

FIG. 4 is an example browser display of a buyer shopping cart;

FIG. 5 is an example browser display of a data collection page;

FIG. 6 is an example browser display of a competitor retailer item page;

FIG. 7 is an example browser display of a revised host retailer item page;

FIG. 8 is an example browser display of a webpage copy used by the host retailer;

FIG. 9 is an example browser display of a further revised host retailer item page;

FIG. 10 is an example browser display of a checkout address page;

FIG. 11 is an example browser display of a shipment and payment method selection page;

FIG. 12 is an example browser display of a payment information page;

FIG. 13 is an example browser display of an invoice page;

FIG. 14 is an example browser display of an order approval page;

FIG. 15 is a schematic illustration of an embodiment of a clerk approval system;

FIG. 16 is a flow diagram showing an embodiment of an approval method;

FIG. 17 is an example browser display of an order approval page with an approved order;

FIG. 18 is an example browser display of an administrative discount setup page;

FIG. 19 shows an example of a discount price calculation;

FIG. 20 shows an alternate embodiment using a relay on the buyer's computer;

FIG. 21 shows an alternate embodiment using a relay computer;

FIG. 22 shows an alternate embodiment in which the host webserver has a second connection to the network;

FIG. 23 is a flow diagram showing an alternate ordering method embodiment;

FIG. 24 is a flow diagram showing an alternate approval method embodiment;

FIG. 25 is an example browser display of an alternate order approval page;

FIG. 26 is an example browser display of a competitor retailer item page accessed from the alternate order approval page;

FIG. 27 is an example browser display of a data collection page having an embedded web browser;

FIG. 28 is an example browser display of a data collection page using a Bitty Browser;

FIG. 29 is an example browser display of a dual window browser used for data collection;

FIG. 30 is an example browser display of an order approval page with an approved order under the alternate approval method of FIG. 24; and

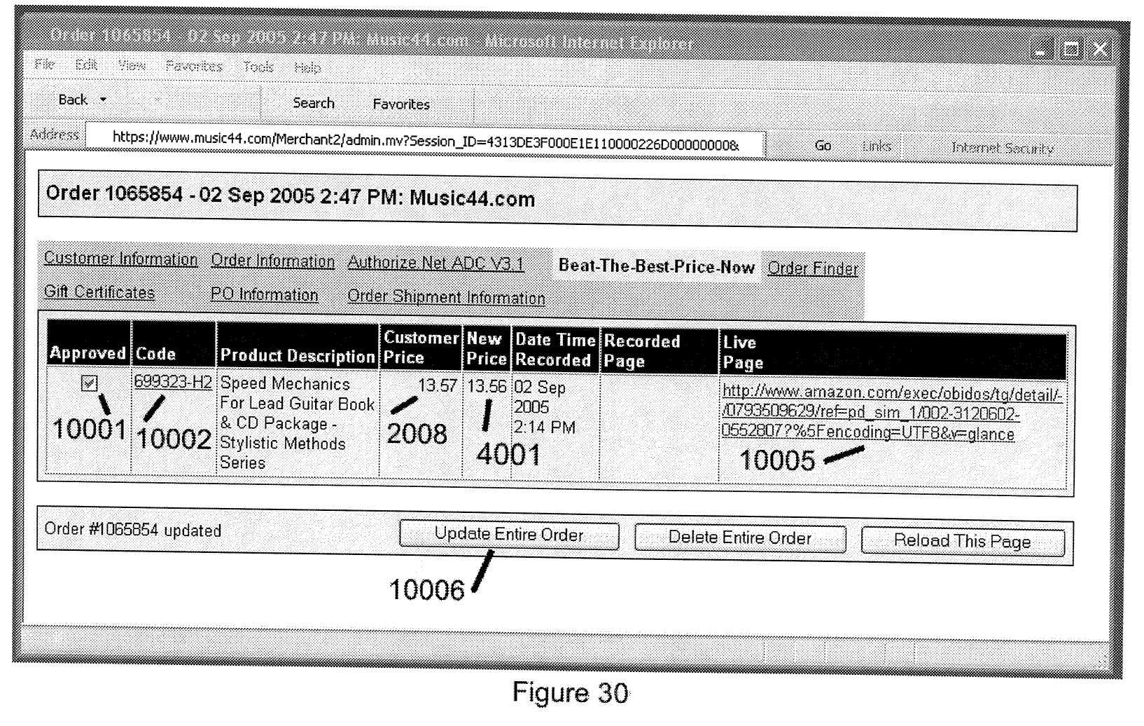

FIG. 31 is an example browser display of a host retailer item page as displayed in browser window 16004 of clerk's computer 16001.

### DETAILED DESCRIPTION OF EXEMPLARY EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

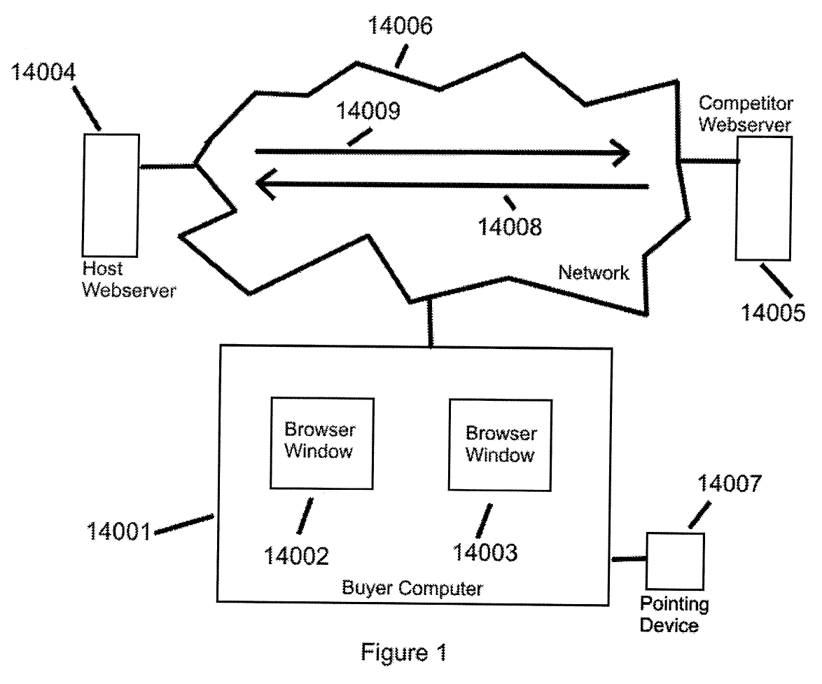

FIG. 1 shows an exemplary embodiment of the present invention which includes a host retailer webserver 14004 for hosting a host retailer website, a competitor webserver 14005 for hosting a competitor's website, a buyer's computer 14001 capable of displaying web browser windows 14002,14003, a pointing device 14007 for selecting objects in the web browser windows, and a network 14006 connecting webservers 14004, 14005 and computer 14001. Computer 14001 also includes a standard input device (e.g., a keyboard) and a video monitor (not shown). The network 14006 may include Local Area Networks (“LANs”) and/or Wide Area Networks (“WANs”), including the Internet and World Wide Web, that are operably coupled to one another via routers, switches, hubs, gateways, proxies, firewalls and/or other devices (not shown).

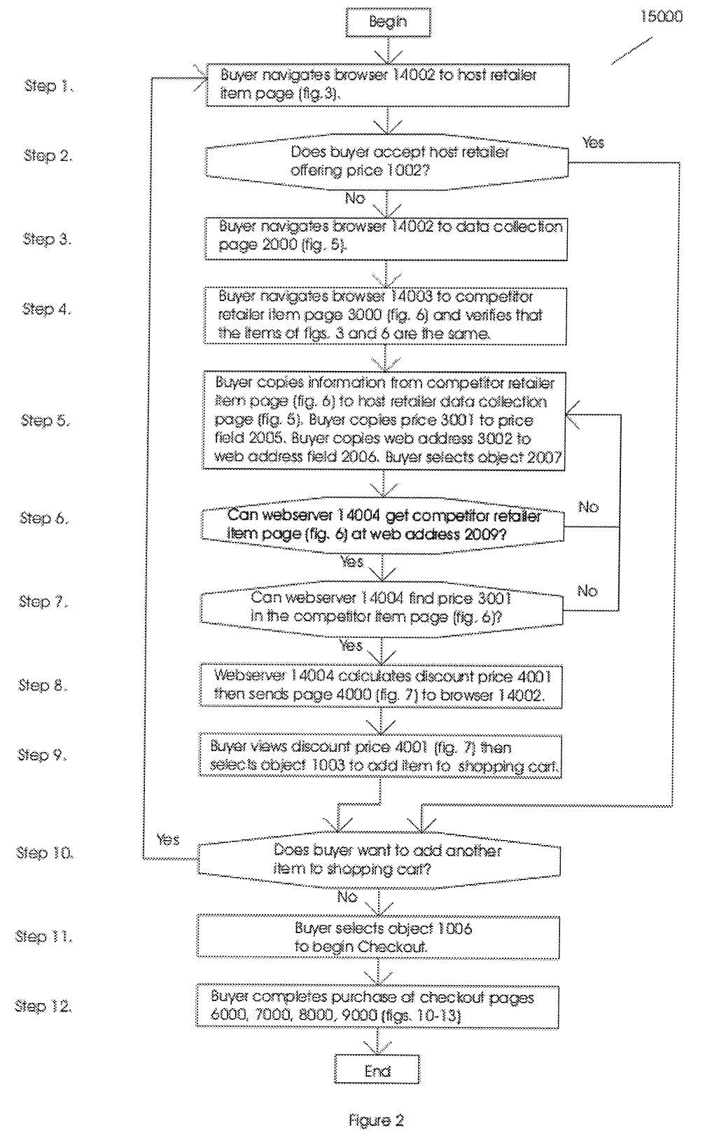

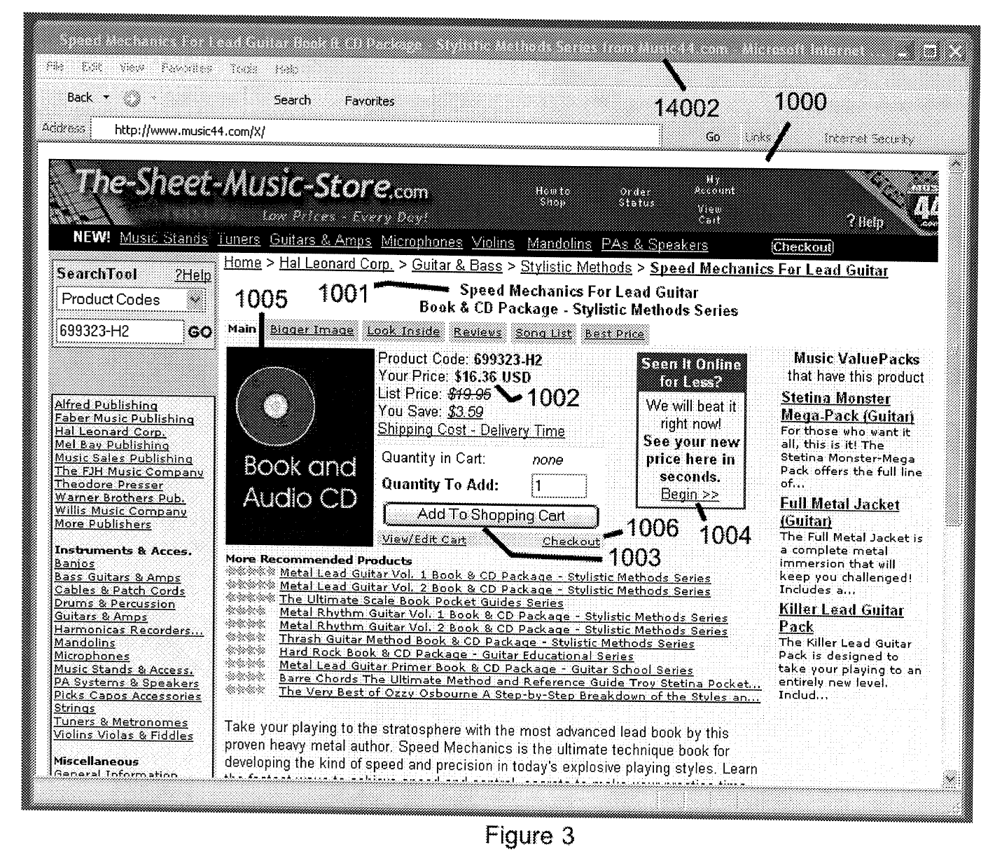

FIG. 2 shows a flow chart of an ordering method 15000 of an exemplary embodiment. At Step 1, the buyer navigates web browser window 14002 to a host retailer item page 1000, an example of which is shown in FIG. 3. The host retailer item page 1000 is supplied by host retailer webserver 14004. The host retailer item page 1000 contains information about an item 12 that host retailer has available for sale. The host retailer item page 1000 can include a description 1001 of item 12, an image 1005 of item 12, an offering price 1002 for item 12, an “Add to Cart” object 1003, a “Beat the Price” object 1004, and a “Checkout” object 1006.

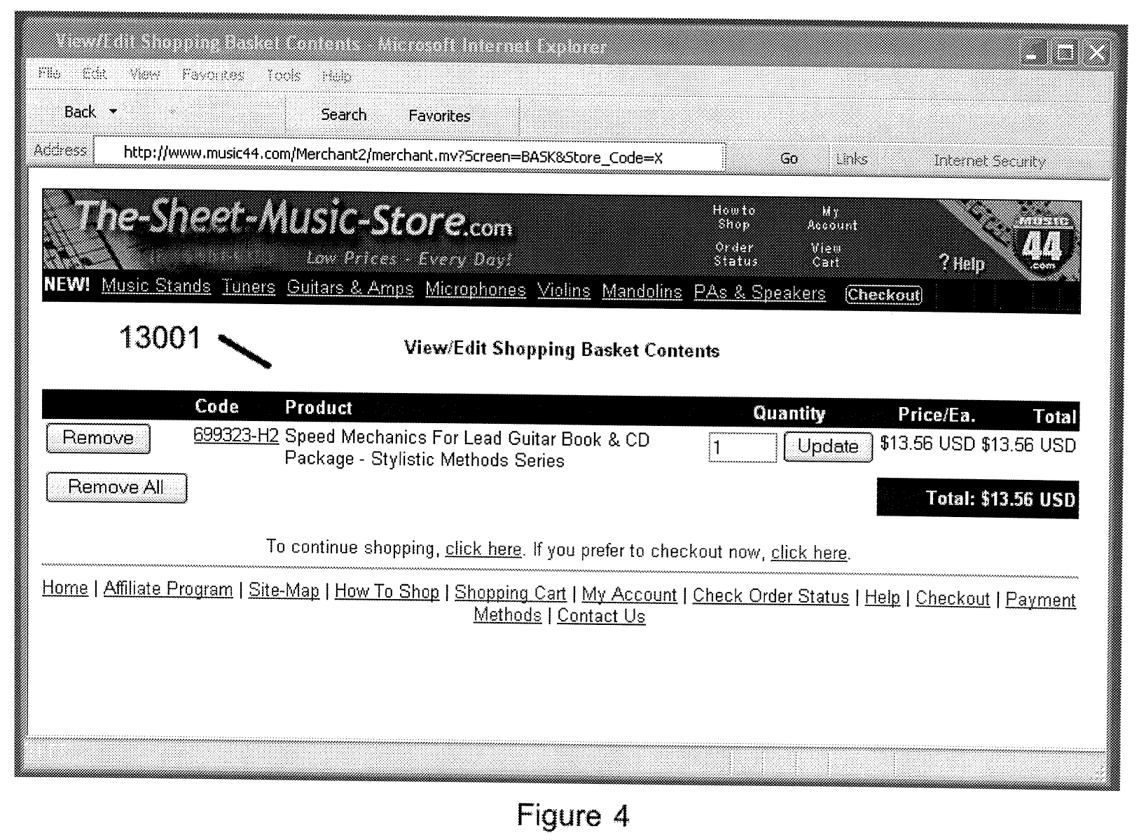

At Step 2, the buyer chooses to accept or reject the offering price 1002 provided by the host retailer. The buyer accepts the offering price 1002 by selecting the “Add to Cart” object 1003 which adds the item 12 to a buyer's shopping cart 13001, an example of which is shown in FIG. 4. After selecting the “Add to Cart” object 1003, control is transferred to Step 10. Alternatively, the buyer rejects the offering price 1002 by selecting the “Beat the Price” object 1004, and control is transferred to Step 3.

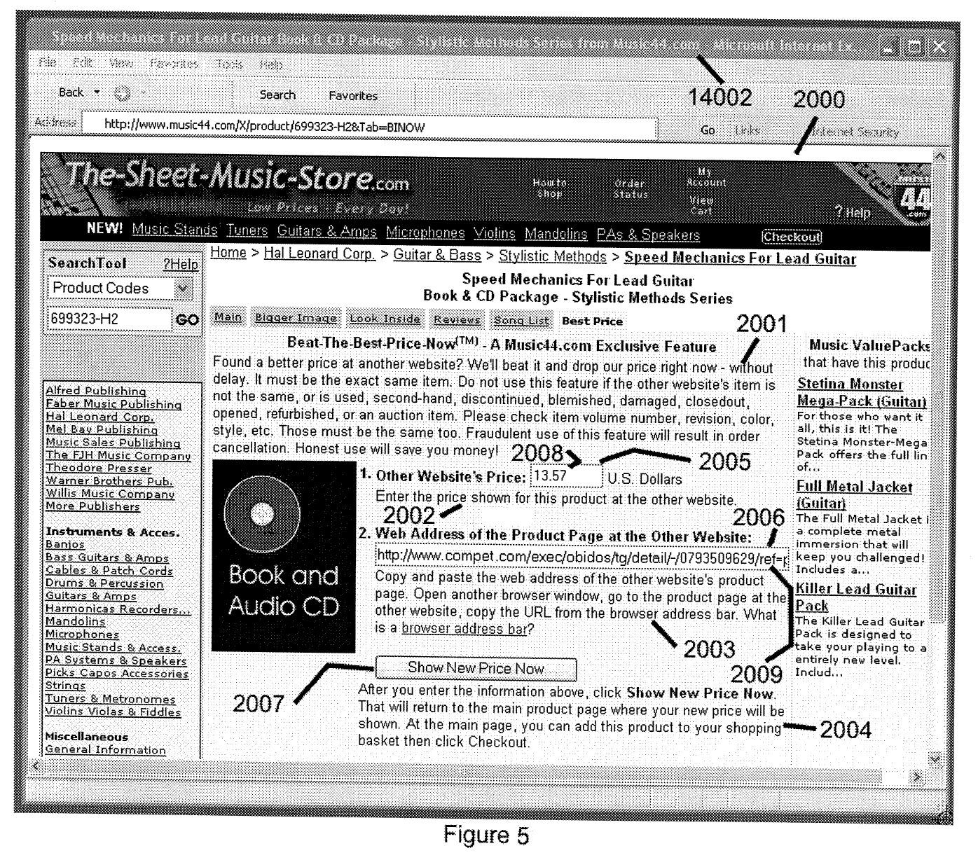

At Step 3, the buyer navigates the browser window 14002 to a data collection page 2000, an example of which is shown in FIG. 5. By selecting the “Beat the Price” object 1004, the buyer indicates his/her desire for the host retailer to participate in the race. The data collection page 2000 can include operating instructions 2001, 2002, 2003 and 2004; a price entry field 2005; a web address entry field 2006; and a “Show New Price” object 2007. Operating instruction 2001 instructs the buyer to find the item 12 on a competitor retailer website.

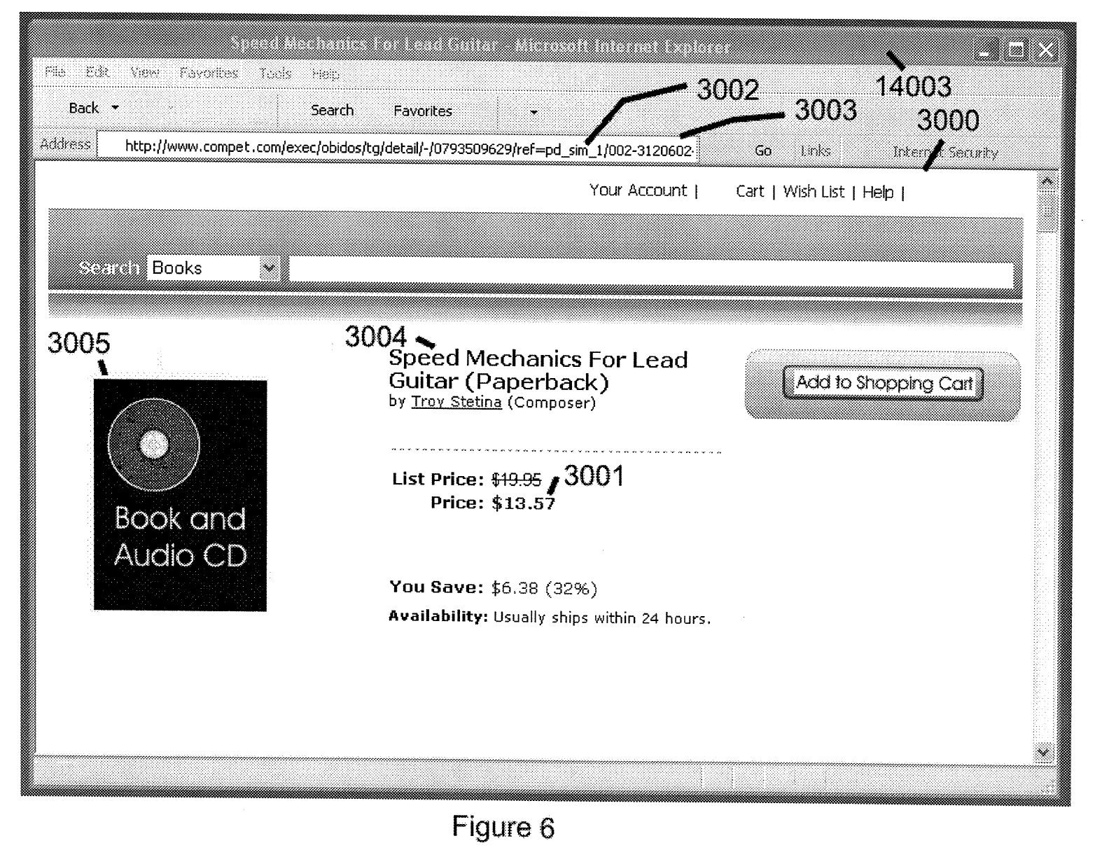

At Step 4, the buyer navigates the browser window 14003 to a competitor website and finds competitor item page 3000 for item 12, an example of which is shown in FIG. 6. The competitor item page 3000 is supplied by the competitor webserver 14005 and has a web address 3002. The competitor item page 3000 contains information about an item 12′ that the competitor retailer has available for sale. The competitor item page 3000 can include a description 3004 of item 12′, an image 3005 of item 12′, an offering price 3001 for item 12′. The buyer compares the item description 1001 and image 1005 on the host retailer item page 1000 (FIG. 3) to the item description 3004 and image 3005 on the competitor item page 3000 (FIG. 6), respectively, in order to verify that the items 12 and 12′ on both retailers pages are the same item 12.

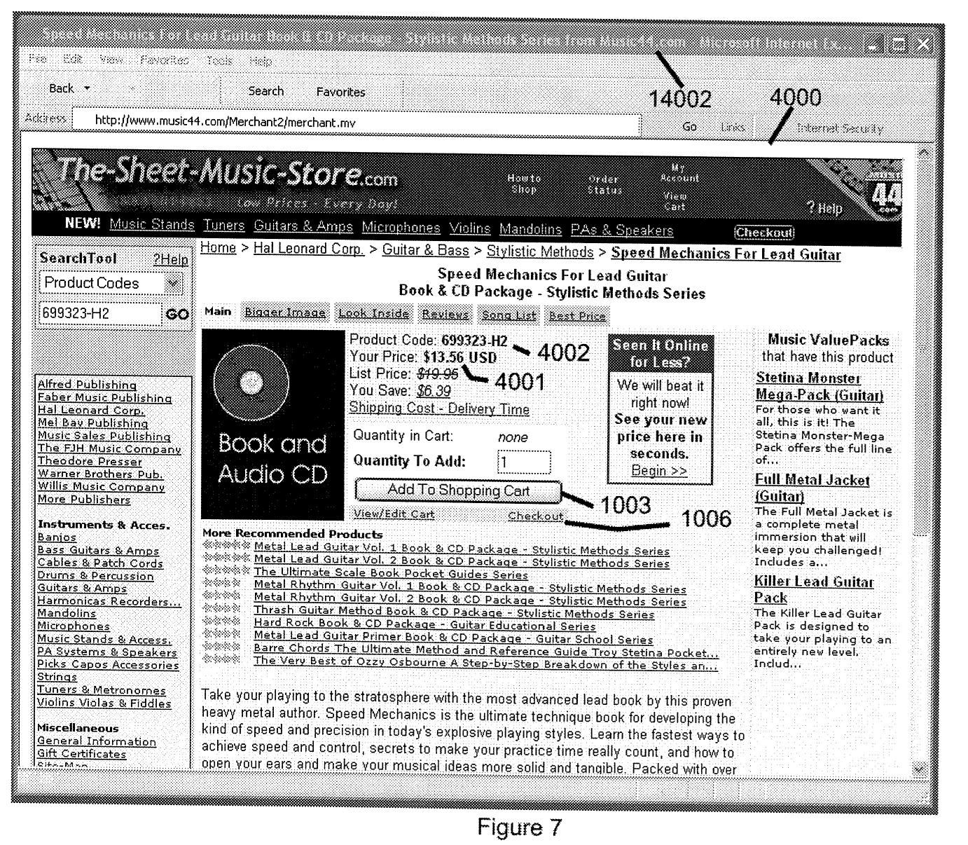

At Step 5, the buyer follows the instructions 2002, 2003 on the data collection page 2000 (FIG. 5) and copies the competitor item price 3001 from the competitor item page 3000 (FIG. 6) to the price entry field 2005 of the data collection page 2000 (FIG. 5); and copies the web address 3002 from the browser address bar 3003 of the competitor item page 3000 to the web address entry field 2006 of the data collection page 2000. The buyer then follows instruction 2004 of the data collection page 2000 and selects the “Show New Price” object 2007 to see the host retailer response on a revised item page 4000, an example of which is shown in FIG. 7.

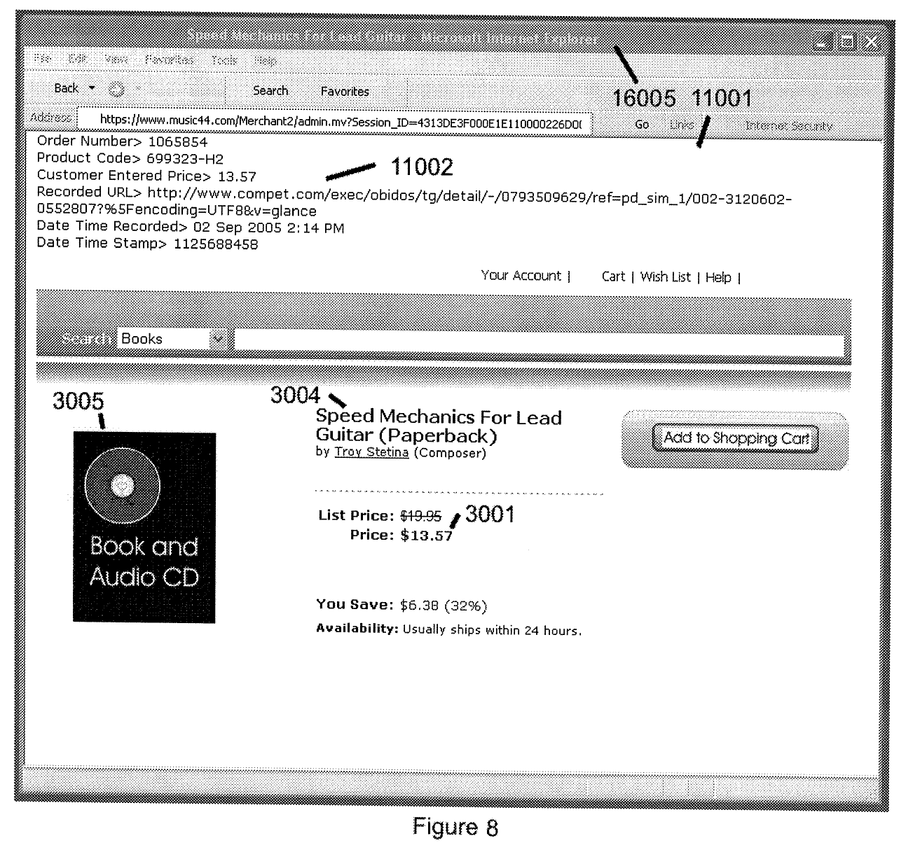

In Step 6, the host retailer webserver 14004 communicates with competitor webserver 14005 in order to get a webpage copy 11001 of the competitor item page 3000 using a buyer-entered web address 2009 (FIG. 5). One embodiment of the webpage copy 11001 is shown in FIG. 8 which includes a page header 11002, the description 3004 of item 12′, the image 3005 of item 12′, and the offering price 3001 for item 12′. If the host webserver 14004 is not able to get a webpage copy 11001 of the competitor item page 3000, it returns the buyer to Step 5 and adds an error message to data collection page 2000 indicating that it was unable to get a copy of the competitor item page 3000 using the buyer-entered web address 2009. If host webserver 14004 is able to get a webpage copy 11001 of the competitor item page 3000, control is transferred to Step 7.

It should be noted that, in this embodiment, the host retailer does not check or verify that items 12 and 12′ are the same during the ordering method 15000. Instead, after the order has been completed by the buyer but before the host retailer approves the transaction and sends the item to the buyer, the host retailer can verify that the items 12 and 12′ are the same. The verification occurs in an order approval method 17000 described below.

In Step 7, the host webserver 14004 tries to find competitor item price 3001 in the webpage copy 11001 of competitor item page 3000. If host webserver 14004 can not find item price 3001, control is transferred to Step 5 and the host webserver adds an error message to data collection page 2000 indicating that it was unable to find the buyer-entered price 2008 in the webpage copy 11001. If host webserver 14004 finds the buyer-entered price 2008 in the webpage copy 11001, control is transferred to Step 8. It should be noted that step 7 is optional; it can be eliminated if the host retailer does not wish to validate the buyer-entered price 2008 on the webpage copy 11001.

At Step 8, the host webserver 14004 saves the webpage copy 11001 to a database and calculates a discount price 4001 according to a predetermined formula specified by the host retailer. The host webserver 14004 then inserts the discount price 4001 into the revised item page 4000 (see FIG. 7) and sends the revised item page 4000 to the browser window 14002.

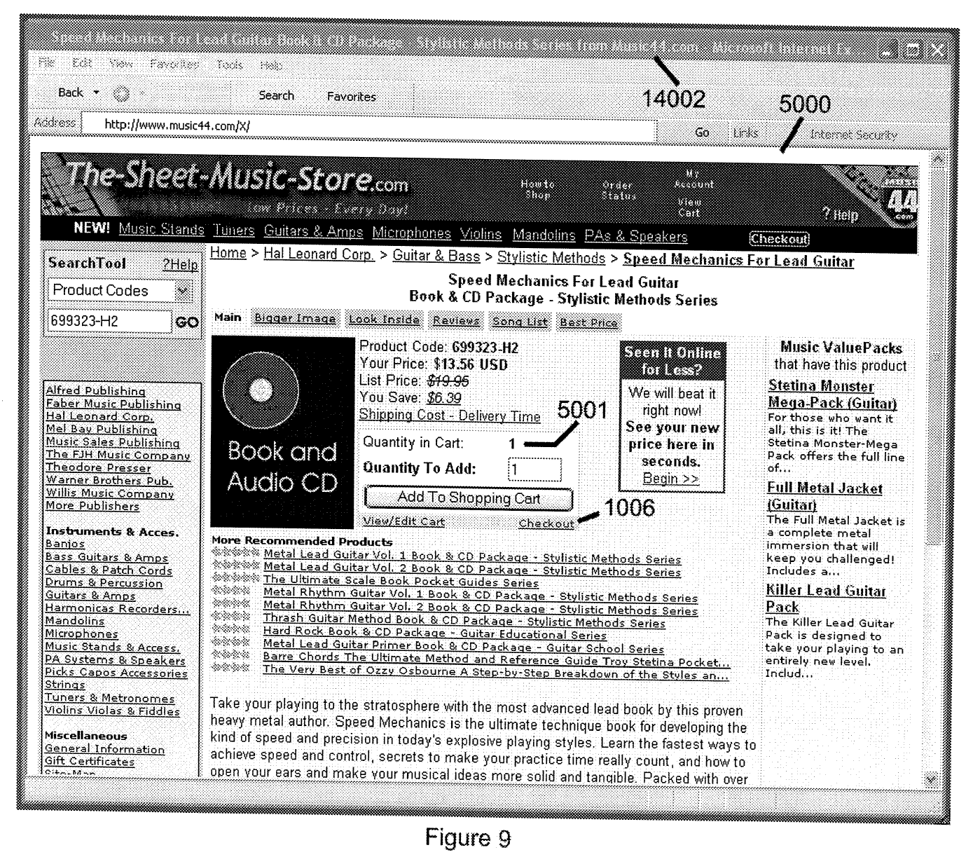

At Step 9, the buyer views the discount price 4001 and can select the “Add to Cart” object 1003 on the revised item page 4000 to add the item 12 to the shopping call 13001 (FIG. 4). After selecting the “Add to Cart” object 1003, the browser window 14002 displays a further revised item page 5000, an example of which is shown in FIG. 9. The further revised item page 5000 includes a basket quantity 5001 of items in the shopping cart 13001 and the “Checkout” object 1006.

At Step 10, the buyer has several options, including returning to Step 1 to do further shopping and checking out. If the buyer wishes to do further shopping, they return to Step 1 and can use the same competitor website or other competitor websites for further price references on a given order. This enables the buyer to receive the lowest prices offered by several retailers at the host retailer website - and enables the host retailer to sell more items.

When the buyer is done adding items to the cart 13001, the buyer can select the “Checkout” object 1006 to begin the checkout process, which takes the buyer to Step 12.

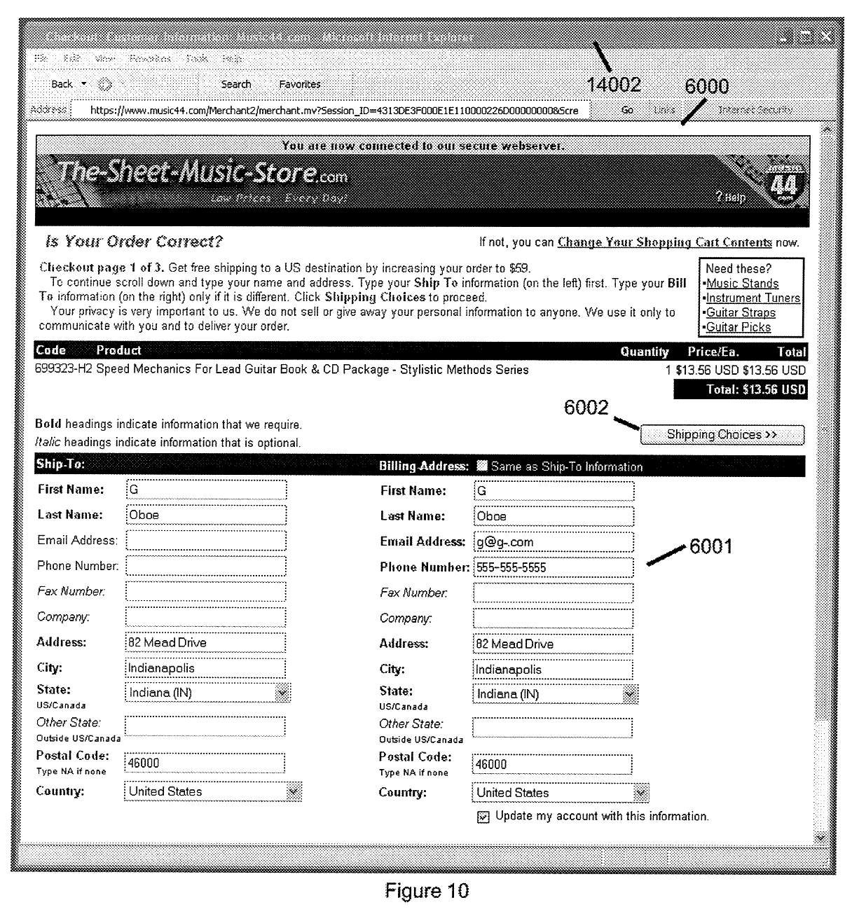

At Step 12, the browser window 14002 displays a checkout address page 6000, an example of which is shown in FIG. 10. The checkout address page 6000 can include a buyer information table 6001 and a “Shipping Choices” object 6002. The buyer Ship-To and Bill-To addresses are entered in the buyer information table 6001. This can be done automatically by the host webserver 14004 or manually by the buyer using a keyboard connected to the buyer computer 14001 or by other methods known in the art.

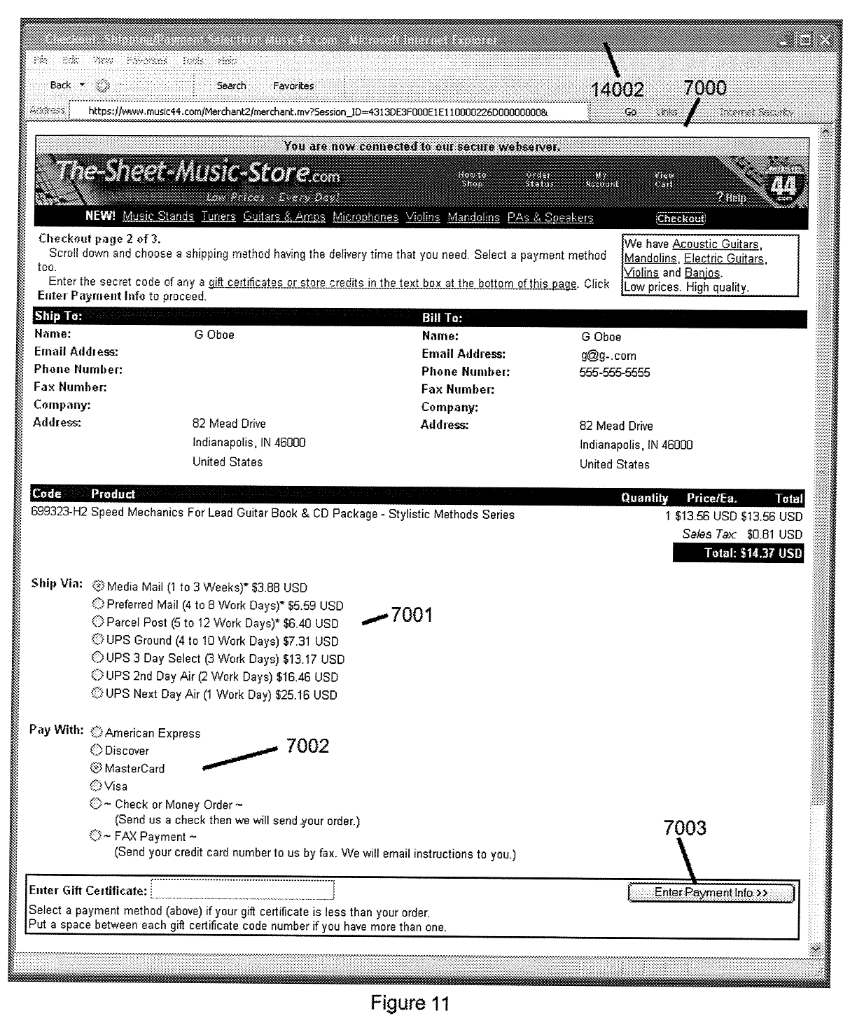

After the buyer's addresses are entered in the buyer information table 6001, the buyer can select the “Shipping Choices” object 6002 to go to a shipment and payment method selection page 7000, an example of which is shown in FIG. 11. The shipment and payment method selection page 7000 can include a shipment method selection table 7001, a payment method selection table 7002, and a “Payment Info” object 7003.

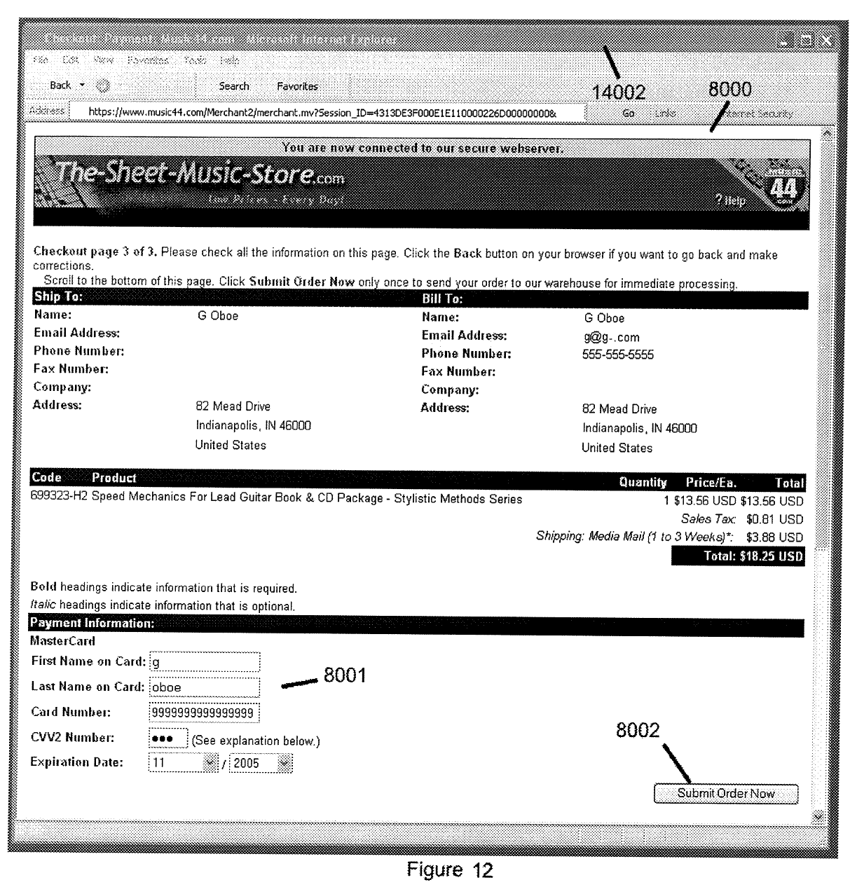

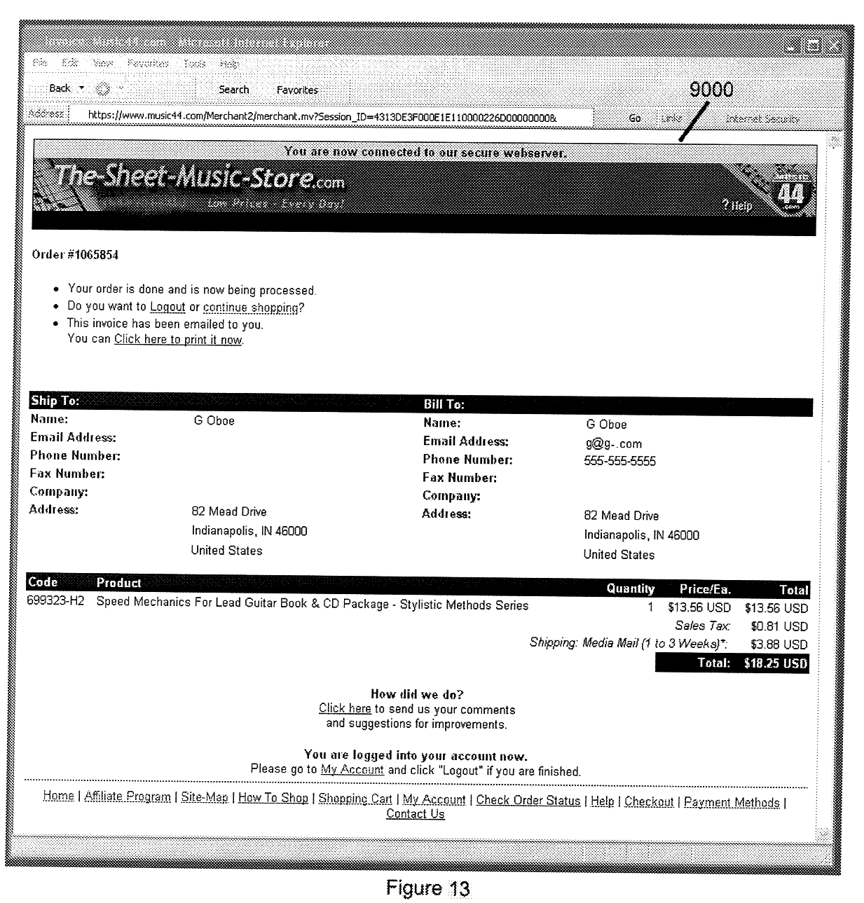

After selecting shipment and payment methods in tables 7001 and 7002, respectively, the buyer can select the “Payment Info” object 7003 to proceed to a payment information page 8000, an example of which is shown in FIG. 12. The payment information page 8000 can include a payment information table 8001 and a “Submit Order” object 8002. The buyer can enter their payment information into the payment information table 8001 and then select the “Submit Order” object 8002 to complete the purchase and proceed to an invoice page 9000, an example of which is shown in FIG. 13.

Referring briefly back to FIG. 1, the network 14006 enables the host webserver 14004 and another webserver, such as competitor webserver 14005 to communicate in real-time with each other. It can often take less than one minute for webservers to establish connections with each other over the Internet and exchange information. The host retailer and the competitor retailer are competitors, and they could be fierce competitors that are not friendly to each other. Nevertheless, the host and competitor webservers can communicate to help the host retailer beat the competitor in the competition over the buyers' purchases.

When the buyer selects the “Show New Price” object 2007 of the data collection page 2000 (FIG. 5) in Step 5, the host retailer webserver 14004 receives a buyer-entered price 2008 from the price entry field 2005 and a buyer-entered web address 2009 from the web address entry field 2006. Utilizing a so-called “screen scraping” process, the host webserver 14004 makes a request 14009 (FIG. 1) to the competitor webserver 14005 using the buyer-entered web address 2009. The competitor webserver 14005 responds by sending a reply 14008 to the host webserver 14004. The reply 14008 includes the competitor item page 3000 shown in FIG. 6.

The host webserver 14004 searches the information in the reply 14008 for the buyer-entered price 2008. If a match is found, the host webserver 14004 can add a page header 11002 to the reply 14008 and save a copy in a database. An example of the saved reply for one embodiment is the webpage copy 11001 shown in FIG. 8. The host webserver 14004 then calculates the discount price 4001 and sends the revised item page 4000 for the host retailer to the browser window 14002. This gives the host retailer flexible control over the method of calculating the discount price 4001, and enables the host retailer to underprice the competitor at will in winning buyers' orders.

The host retailer can sell a given item to different buyers at different prices. Buyers who accept the offering price 1002 at Step 2 (FIG. 2) proceed directly to Step 10 and pay a potentially higher price than the buyers who do not accept the offering price 1002 and proceed to Step 3. One embodiment for implementing this aspect includes a discount database record 100 (Table 1) that stores the header information for the shopping cart 13001. The discount database record 100 can include a birn_code field and a birn_price field, which hold the item code and the item price, respectively. Collectively the discount database records 100 with the added fields comprise a real-time price discounting database 101. The host webserver 14004 can allocate a shopping cart 13001 for each buyer by allocating a different discount database record 100 for each buyer in the real-time price discounting database 101 on the host retailer website. Since each buyer can have his/her own discount record 100, each buyer can have his/her own price stored in the birn_price field for the item indicated by the product code stored in the birn_code field. Then on future visits to the host website, the price for the item will be displayed as the previously saved discount price stored in the birn_price field. Additionally, an expiration option can be implemented on the host website whereby the discount price expires after a predetermined period, for example 30 days. Using the expiration option, the discount record 100 is no longer used after the predetermined period and on future visits to the host website, the price for the item will be displayed as the then current offering price.

TABLE 1

| | |
|---|---|
| session_id | CHAR(64), |
| cust_id | NUMBER, |
| basket_id | NUMBER, |
| lastupdate | CHAR(10), |
| order_id | NUMBER, |
| order_proc | BOOL, |
| ship_fname | CHAR(50), |
| ship_lname | CHAR(50), |
| ship_email | CHAR(50), |
| ship_comp | CHAR(50), |
| ship_phone | CHAR(50), |
| ship_fax | CHAR(50), |
| ship_addr | CHAR(100), |
| ship_addr2 | CHAR(100), |
| ship_city | CHAR(50), |
| ship_state | CHAR(50), |
| ship_zip | CHAR(50), |
| ship_cntry | CHAR(50), |
| bill_fname | CHAR(50), |
| bill_lname | CHAR(50), |
| bill_email | CHAR(50), |
| bill_comp | CHAR(50), |
| bill_phone | CHAR(50), |
| bill_fax | CHAR(50), |
| bill_addr | CHAR(100), |
| bill_addr2 | CHAR(100), |
| bill_city | CHAR(50), |
| bill_state | CHAR(50), |
| bill_zip | CHAR(50), |
| bill_cntry | CHAR(50), |
| noship | BOOL, |
| tax | NUMBER(10.2), |
| shipping | NUMBER(10.2), |
| ship_id | NUMBER, |
| ship_data | CHAR(100), |
| pay_id | NUMBER, |
| pay_data | CHAR(100), |
| advsource | CHAR(100), |
| total | NUMBER(10.2), |
| ccattempts | NUMBER(2.0), |
| pack_id | NUMBER, |
| birn_code | CHAR(50), |
| birn_price | NUMBER(10.2) |

After the host webserver 14004 confirms the competitor price in Step 7, the webserver 14004 can save the result in the discounting database 101 by storing the discount price 4001 in the birn_price field and storing the product code 4002 in the birn_code field. The product code 4002 can be determined by a products database 13 of the host webserver 14004. The products database 13 stores information used by the webserver 14004 to create host retailer item pages, an example of which is page 4000 (FIG. 7). The products database 13 includes the product code 4002, the item image 1005, and the description 1001 (FIG. 3). The products database 13 is the source of the product code 4002 which the host webserver 14004 copies to other databases, files, and the host retailer item pages. The products database 13 can have a plurality of records each corresponding to a different item offered for sale by the host retailer at its website. Each item in the products database 13 can be differentiated by a different set of characters for product code 4002. While the host webserver 14004 creates an item page for the buyer, such as the revised item page 4000 (FIG. 7), the host webserver 14004 compares the item product code 4002 of the item page 4000 to the product code stored in the birn_code field of the discount record 101. If there is a match, the host webserver 14004 retrieves the discount price 4001 from the birn_price field and displays it on the item page 4000 instead of the initial offering price 1002. Since the comparison is done for each buyer who can have different product codes and prices saved in his/her birn_code and birn_price fields respectively, the host retailer can sell the same item to different buyers at different prices.

In an alternate embodiment of the invention, discount records 100 having a birn_code field and a birn_price field are not used for the shopping cart 13001. Instead, discount records that include the discount price 4001 and a copy of the product code 4002 are stored in a buyer file 102 of a discount file system 103 of the host webserver 14004. The host webserver 14004 can store a discount record in the buyer file 102 for each product code 4002 in each buyer's shopping cart 13001 and maintains a one-to-one relationship between each buyer and each buyer file 102.

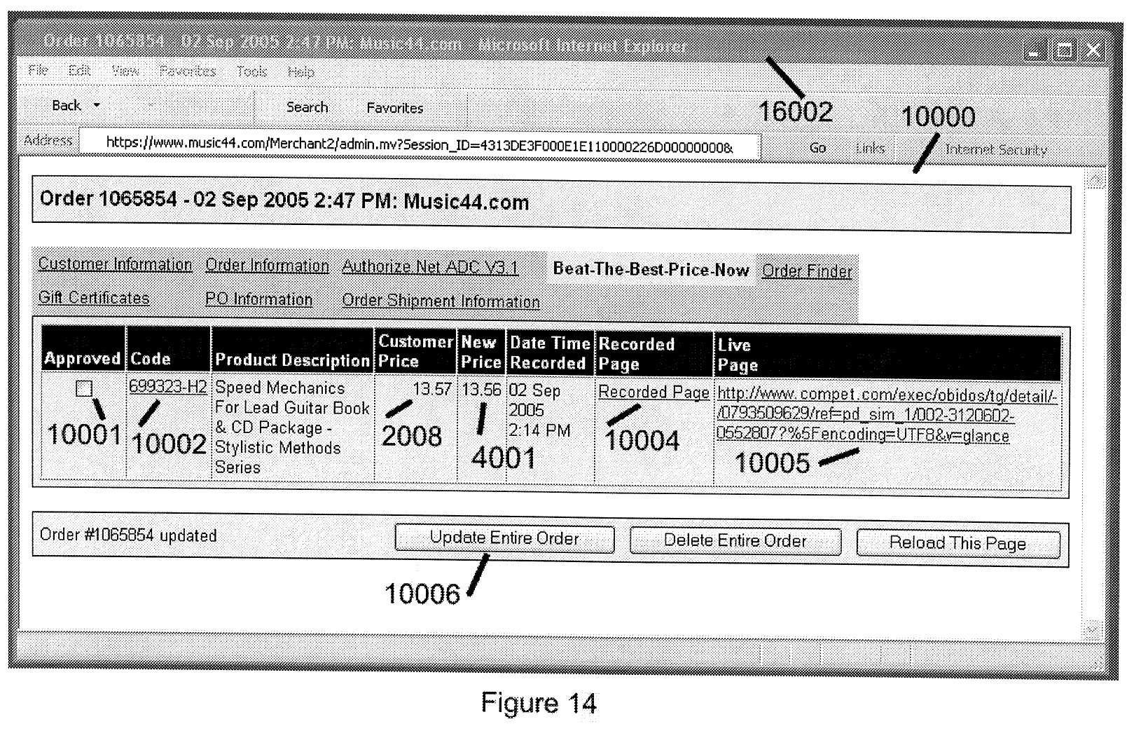

In another embodiment of the invention, the host webserver 14004 stores information in a discount database 202. The host webserver 14004 allocates a discount record 33002 (shown in Table 1A) in the discount database 202 for each buyer using the host retailer website. The discount record 33002 includes a data field for information items shown in an order approval page 10000, an example of which is shown in FIG. 14. FIG. 14 shows a feature of the administrative services of the host webserver 14004 which can be accessed by a clerk of the host retailer after the clerk's identity is authenticated by the host webserver 14004 which is described below.

TABLE 1A

| | |
|---|---|
| session_id | CHAR(64), |
| approval_checkbox | BOOL, |
| birn_code | CHAR(50), |
| buyer_entered_price | NUMBER(10.2), |
| birn_price | NUMBER(10.2) |
| date_time | CHAR(50), |
| recorded_page | MEMO, |
| live_page_url | CHAR(254), |

The order approval page 10000 includes an approval checkbox 10001, a product code link 10002, the buyer-entered price 2008, a webpage copy link 10004, a competitor web address link 10005 (which displays the buyer-entered web address 2009), and an “Update Order” object 10006.

In this embodiment, the host webserver 14001 saves a unique data string in the session_id field so that it can identify each buyer using the host retailer website. The host webserver 14001 can utilize the session_id field to maintain a one-to-one correspondence between each buyer and each discount record 33002. The approval _checkbox field saves the state of the approval checkbox 10001. The birn_code field saves a copy of the product code 4002 which is displayed as the product code link 10002. Webserver 14001 accesses the discount database 202 and the product database to retrieve information displayed in the example of FIG. 14. The buyer_entered_price field saves buyer-entered price 2008 which is 13.57 shown in the example of FIG. 14. The birn_price field saves discount price 4001 which is shown under the “New Price” heading in FIG. 14. The date_time field saves the date and time that record 33002 was written to the discount database 202. In the example of FIG. 14, the record shown was written to the discount database on Sep. 20, 2005 at 2:14 PM. The recorded_page field saves a copy of the competitor item page 3000, and selecting the webpage copy link 10004 of FIG. 14 can display the webpage copy 11001 shown in FIG. 8. The live_page_url field saves the buyer-entered web address 2009 which is the same as the web address 3002 of the competitor item page 3000, and is displayed under the “Live Page” heading in FIG. 14 as the competitor web address link 10005.

It should be noted that the host webserver 14004 can write information to the records of Table 1 and/or Table 1A at any step after step 6 (FIG. 2).

Administrative Services

The administrative services of the host webserver 14004 can be accessed by a clerk of the host retailer after his/her identity is authenticated by the host webserver 14004. Authentication can be achieved by each clerk submitting a login name and password to the host webserver 14004, which determines whether the clerk is in a predetermined list of clerks who are authorized to access the administrative services of the host webserver 14004. It should be noted that a clerk can be a person, a computer program, or any other means for performing administrative tasks on host webserver 14004. The administrative services of the host webserver 14004 are private. By providing the clerk a username and password, or by providing the clerk other means for authenticating its identity to webserver 14004, the host retailer grants the clerk access to the administrative services.

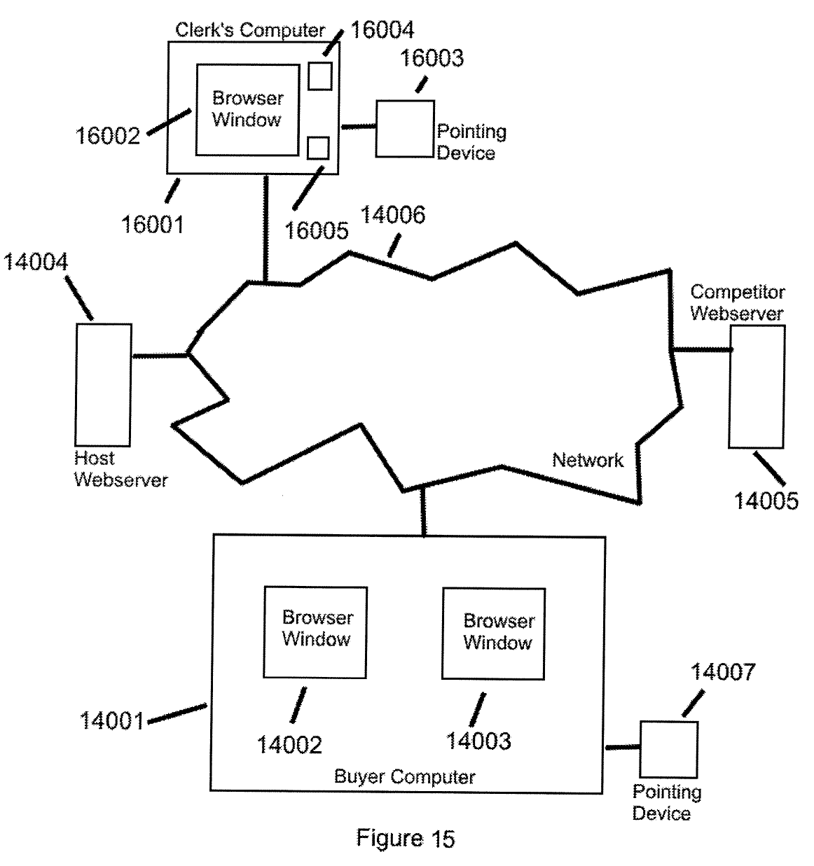

FIG. 15 shows an embodiment of the elements that enable the clerk to review buyers' orders and record whether the orders are approved or unapproved. FIG. 15 shows a clerk's computer 16001 with a video monitor that can display multiple browser windows 16002, 16004, 16005; a pointing device 16003 for selecting objects in the browser windows; and a connection to the network 14006.

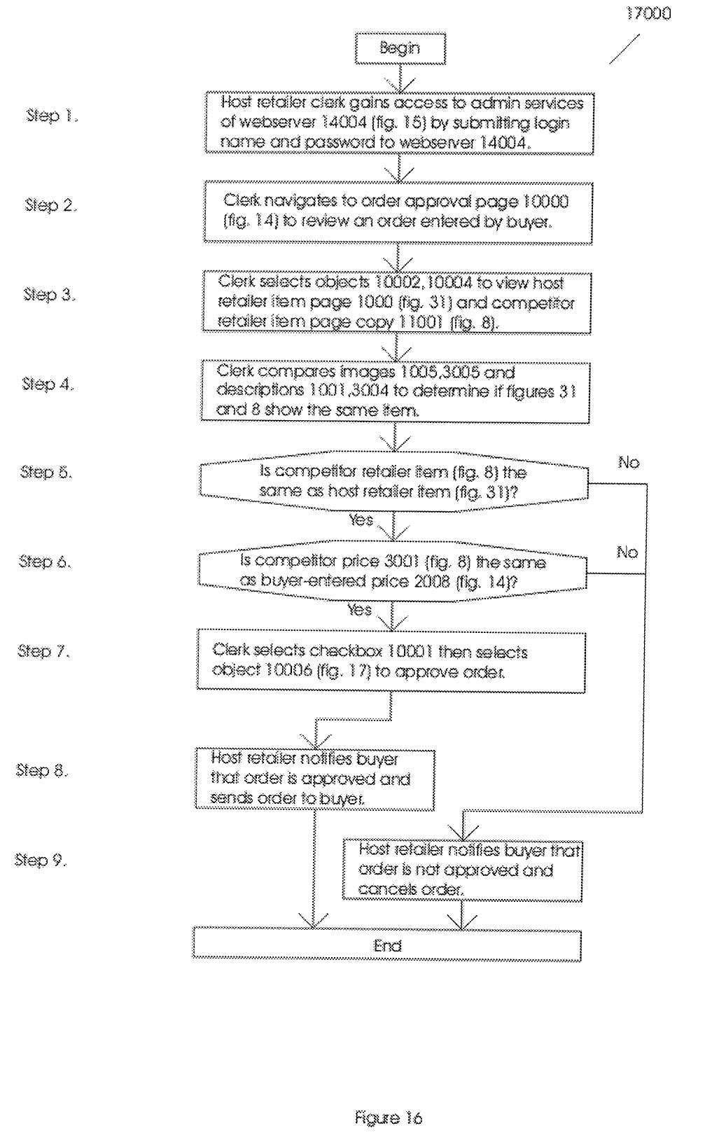

FIG. 16 shows a flow chart of an embodiment of the order approval method 17000. In Step 1, the clerk gains access to the administrative services of the host webserver 14004 by entering authorization information. When the host webserver 14004 confirms that the clerk is authorized to access the administrative services, control is passed to Step 2.

In Step 2, the clerk navigates the browser window 16002 to an order approval page 10000, an example of which is shown in FIG. 14. The information on the order approval page 10000 was collected and saved by the host retailer webserver 14004 during the Steps of FIG. 2.

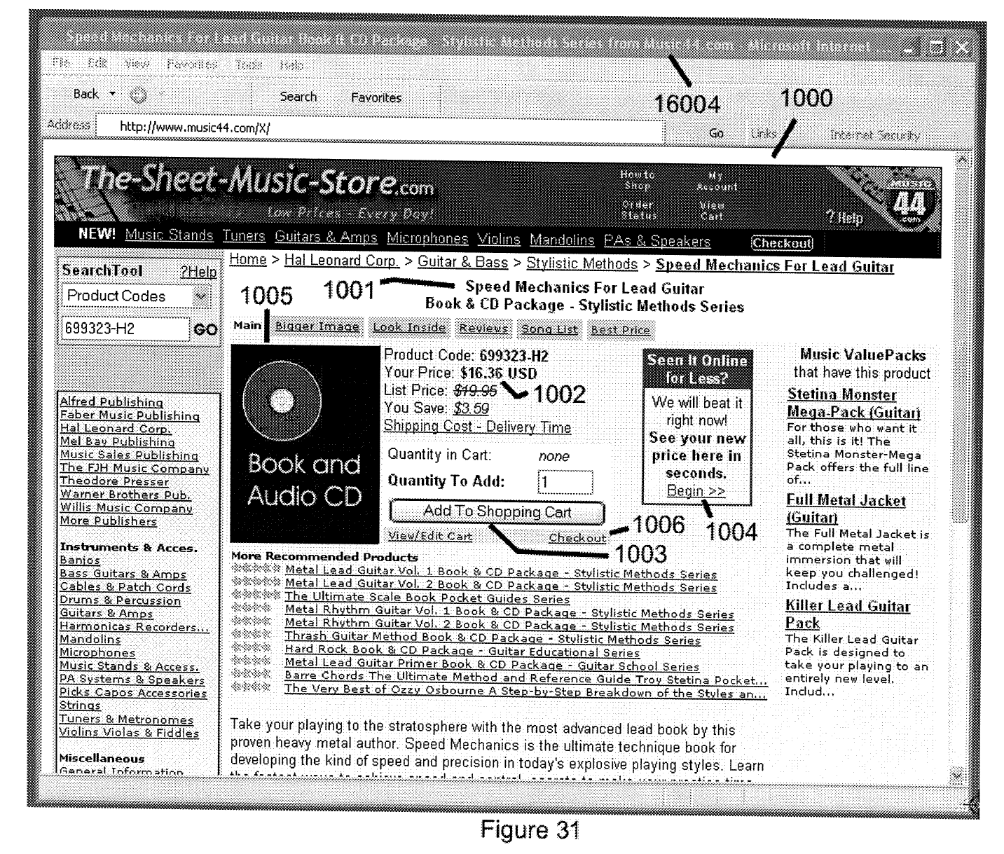

At Step 3, the clerk selects the product code link 10002 to view the host retailer item page 1000 (FIG. 31), which can be displayed in browser window 16004. The clerk also selects the webpage copy link 10004 to view the competitor webpage copy 11001 (FIG. 8), which can be displayed in browser window 16005.

At Step 4, the clerk compares the item image 1005, the item description 1001 and other relevant information on the host retailer item page 1000 with the item image 3005, the item description 3004 and other relevant information on the competitor webpage copy 11001.

At step 5, the clerk makes a judgment whether or not item 12 of the host retailer item page 1000 is the same as item 12′ of the competitor webpage copy 11001. If the items are not the same in the clerk's opinion, the clerk proceeds to Step 9 and the buyer's order is not approved. On the other hand, if the items are the same in clerk's opinion, the clerk proceeds to Step 6.

At step 6, the clerk determines whether the competitor offering price 3001 on the competitor webpage copy 11001 is the same as buyer-entered price 2008 on the order approval page 10000. If the prices are not the same in the clerk's opinion, the clerk proceeds to Step 9 and the buyer's order is not approved. On the other hand, if the prices are the same in the clerk's opinion, the clerk proceeds to Step 7.

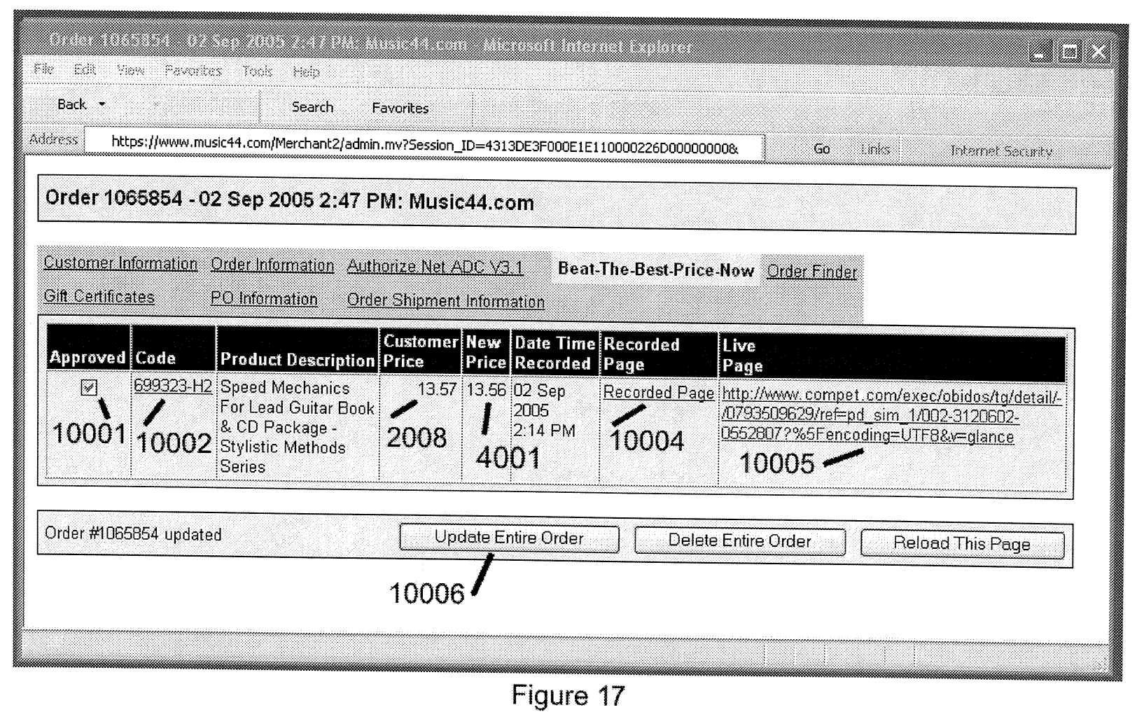

At Step 7, the clerk selects the approval checkbox 10001 and then selects the “Update Order” object 10006 to approve the buyer's order. An example of the order approval page 10000 with the approval checkbox 10001 selected is shown in FIG. 17. In response to the clerk's approval, the host retailer webserver 14004 transfers control to Step 8.

At Step 8, the host retailer webserver 14004 sends an acknowledgement to the buyer indicating that the buyer's order is approved. In one embodiment of the invention, the webserver 14004 sends the buyer a message via electronic mail (e-mail) in response to the clerk completing the steps in FIG. 9. The message indicates whether the buyer's order was approved or not. In another embodiment, the clerk sends the e-mail message instead. Alternatively, the clerk or the webserver 14004 can post the message to the customer's private login account on the webserver 14004. It should be noted that any means for communicating the approval status of the order can be used to notify the buyer whether the order is approved or not approved. In yet another embodiment, the means for notifying the buyer of order approval can be the host retailer delivering the purchased item to the buyer; and the means for notifying the buyer of order non-approval can be the host retailer canceling the order and refunding the buyer's credit card the purchase amount less a service fee. The service fee can be greater than or equal to $0.00 (zero). In another embodiment, the buyer can initiate an appeal to the host retailer for reconsideration if the order was not approved. The buyer can provide additional information to the host retailer to change the clerk's opinion and approve the order.

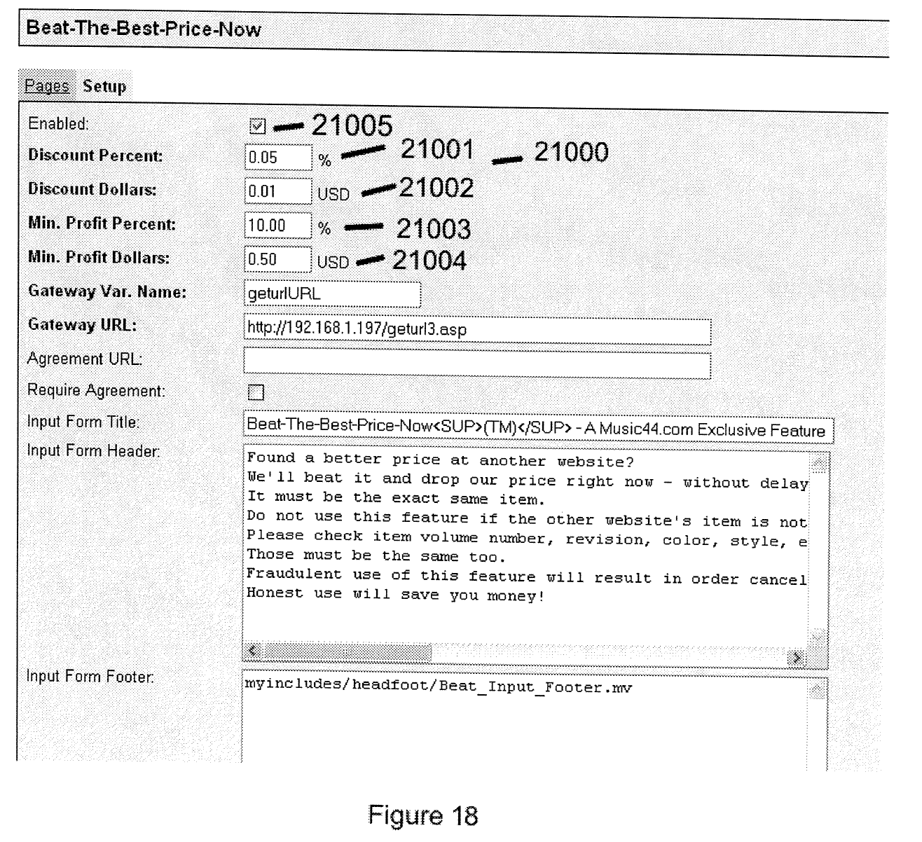

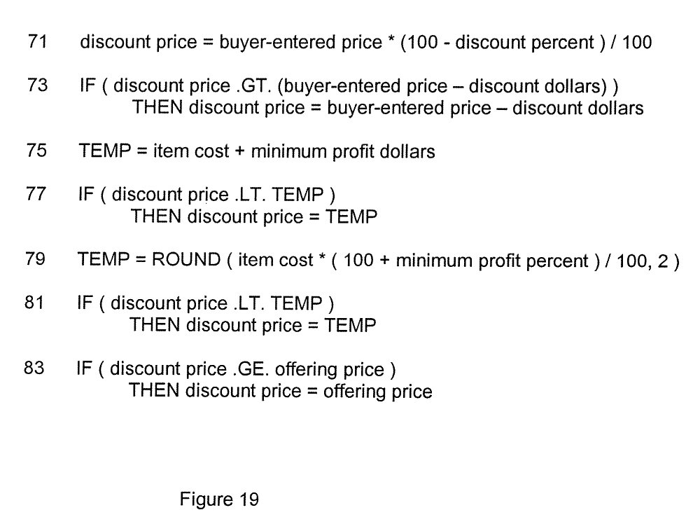

An embodiment of an administrative discount setup 21000 is shown in FIG. 18 which includes a discount percent field 21001, a discount dollars field 21002, a minimum profit percent field 21003, and a minimum profit dollars field 21004, and an enable checkbox 21005. In the example shown, the discount percent field 21001 contains the value 0.05% (0.0005), the discount dollars field 21002 contains the value $0.01 (one penny), the minimum profit percent field 21003 contains the value of 10.00% (0.1000), the minimum profit dollars field 21004 contains the value of $0.50 (fifty cents), and the enable checkbox 21005 is checked in order to activate discounting at the host retailer website. The host webserver 14004 stores the administrative discount setup 21000 in a database and applies it to discount price calculations such as those shown the example of FIG. 19. These calculations or other discount price calculations that provide discount prices approved by the host retailer can be used by webserver 14004 in step 8 of FIG. 2 to determine the discount price 4001.

The formulas and variables of the discount price calculations are defined by the host retailer (for example, by a sales manager of host retailer) and can be changed in response to changing market conditions, supplier agreements, sales volume changes, etc. Different discount price calculations can be used for different items to account for variations in parameters between items. This arrangement gives host retailer control over the method of calculating discount price 4001.

FIG. 19 provides an example of a discount price calculation that uses the administrative discount setup 21000 of FIG. 18. In step 71, an initial discount price is computed using the buyer-entered price 2008 and the discount percent value from the discount percent field 21001. In Step 73, the value of the buyer-entered price 2008 minus the discount dollars value from the discount dollars field 21002 is computed. If the discount price from Step 71 using the discount percent is greater than this computed value using the discount dollars, then the discount price is revised and set equal to the computed value using the discount dollars. In Step 75, a temporary cost value is computed using the item cost for the host retailer and the minimum profit dollars from the minimum profit dollars field 21004. In step 77, if the discount price is less than this temporary cost value, then the discount price is revised and set equal to the temporary cost value. In Step 79, a temporary percent value is computed using the item cost for the host retailer and the minimum profit percent from the minimum profit percent field 21003. In step 81, if the discount price is less than this temporary percent value, then the discount price is revised and set equal to the temporary percent value. In Step 83, the discount price resulting from this discount price calculation is compared with the previous offering price 1002. If the computed discount price is greater than or equal to the previous offering price 1002, then the discount price is revised and set equal to the previous offering price 1002. The resulting discount price is the discount price 3001.

Offline Analogy

Embodiments of the present invention are more than just an online version of the same business method that buyers and sellers normally use offline. The following example will illustrate some of the differences that would be encountered in an offline version of a price comparison and revision method. An embodiment of the price comparison and revision method for the present invention is shown in FIG. 2.

In example offline version could proceed as follows:

Step 1. A buyer walks into a first retailer with the intention of purchasing a pair of shoes. The buyer finds the shoes in his/her preferred size and color.

Step 2. The buyer rejects the first retailer's price because he/she thinks it is too high.

Step 3. The buyer walks to a checkout lane and tells a cashier at the first retailer that he/she wants a price discount.

Step 4. While the cashier at the first retailer waits, the buyer uses a phone to call a second retailer. An employee at the second retailer tells the buyer that the second retailer has the same shoes in the same size and color on sale for a lower price than the first retailer. The buyer learns the sale price at the second retailer and also learns the location of the shoes (aisle number, shelf number and box number) in the second retailer store.

Step 5. The buyer gives the second retailer information (the second retailer price and location of the shoes in the second retailer store) to the cashier of the first retailer.

Steps 6. The cashier of the first retailer sends a photographer to the second retailer who finds the shoes at the given location and photographs them. The photograph also captures an image of a sign near the shoes showing the sale price of the second retailer.

Steps 7. The photographer returns to the first retailer and gives the photograph to the cashier of the first retailer. Neither the cashier nor the photographer knows at this point if in fact the photograph shows the same pair of shoes that the first retailer has (nor do they care because that is not likely to be in their job descriptions). Neither do they know or care whether the sign in the photograph refers to the shoes in the photograph.

Step 8. The cashier of the first retailer puts the photograph into a file and then uses a calculator to work a predetermined formula given by a sales manager of the first retailer. The formula provides a discount price that is less than or equal to the price of the second retailer.

Step 9. The buyer accepts the discount price and puts the shoes in his/her shopping cart. But first the cashier of the first retailer changes the price of only that one pair of shoes—perhaps by attaching a paper tag and writing the discount price on it. The cashier also indicates on the tag that there is a photograph on file for the pair of shoes sold to that buyer.

Step 10. The buyer then decides to purchase another pair of shoes for a friend so he/she walks away from the cashier and goes back to Steps 1 through 9 to put another pair of shoes in his/her shopping cart.

Steps 11, 12. The buyer is ready to checkout and gives a credit card to the cashier for payment. The cashier charges the buyers credit card for the two pairs of shoes.

Finally, the buyer attempts to walk out of the first retailer store but is stopped by a clerk who asks to see a cash register receipt and the shoes. The buyer complies and waits while the clerk finds and reviews the photographs taken earlier. The clerk returns the second pair of shoes to the buyer but keeps the first pair. In the clerk's opinion, the shoes in the first photograph from the second retailer's store do not match the first pair of shoes purchased from the first retailer. The clerk makes an apology to the buyer and the buyer leaves—a little upset and embarrassed by the whole experience. The clerk gives the shoes back to the cashier who then cancels the first pair of shoes from the buyer's credit card transaction. Later that day, the credit card transaction settles and the buyer's card is charged for only the second pair of shoes.

It is apparent that the above steps taken offline would take a significant amount of time, including travel time and waiting time, and are potentially very embarrassing for the buyer. The speed and broad access of the Internet greatly reduces the time, and the relative anonymity of the Internet relieves that embarrassment but also increases the potential for intentional buyer fraud. Another drawback of an offline price comparison and revision method is that buyers in close physical proximity to each other could readily share information about competitor retailers and obstruct the first retailer's ability to sell an item at different prices to different buyers.

It should be noted that the photos, the second retailer prices, and the shoe locations in the second retailer store can be saved in the file at any step after step 6. If the photos are not saved in the file, the clerk of step 11,12 can simply send the photographer out again to take more photos. If the prices and shoe locations of the second retailer are saved in the file, the clerk can use that saved information to instruct the photographer where to go. If the prices and shoe locations of the second retailer are not saved in the file, the clerk can ask the buyer to provide that information.

Results

The inventor installed an embodiment of the present invention on a webserver at http://www.music44.com. That is the website of Music44.com, Inc., an Indiana corporation and online retailer of sheet music, music books, musical instrument and accessories. The results were surprising.

Firstly, the invention was deployed without advertising or promotion. Nevertheless, commercial success was immediate. Buyers began using the invention within hours of deployment and Music44.com won orders away from other retailers, including major online retailers as well as smaller retailers.

Secondly, some of the Music44.com staff personnel were concerned that buyers would use the invention fraudulently. For example, buyers had a means to change the selling price, and could intentionally enter an incorrect (lower) price for the competitor price 2008. Alternatively, a buyer could intentionally reference an incorrect or invalid competitor web address. However, that did not happen. In five days of use, not one buyer used the invention fraudulently.

Thirdly, some of the staff personnel at Music44.com were concerned that buyers would be confused and enter the wrong information unintentionally—wrong web address and/or wrong price. That happened only once—the first order. The buyer confused a Volume 2 music book at music44.com with a Volume 1 music book at a competitor's website. The inventor clarified the instructions on the data collection page 2000, and no further mistakes were found. Every order was approved during the period of time when all incoming orders were being monitored.

In the months that followed, further monitoring of incoming orders revealed that less than 1% of buyers tried to use the invention fraudulently. Of course, none of the fraudulent orders were approved. In a further embodiment, a warning was added to indicate that misuse of the discount feature would result in order cancellation and a cancellation service fee. This warning further reduced the fraudulent order rate.

### ALTERNATIVE EMBODIMENTS

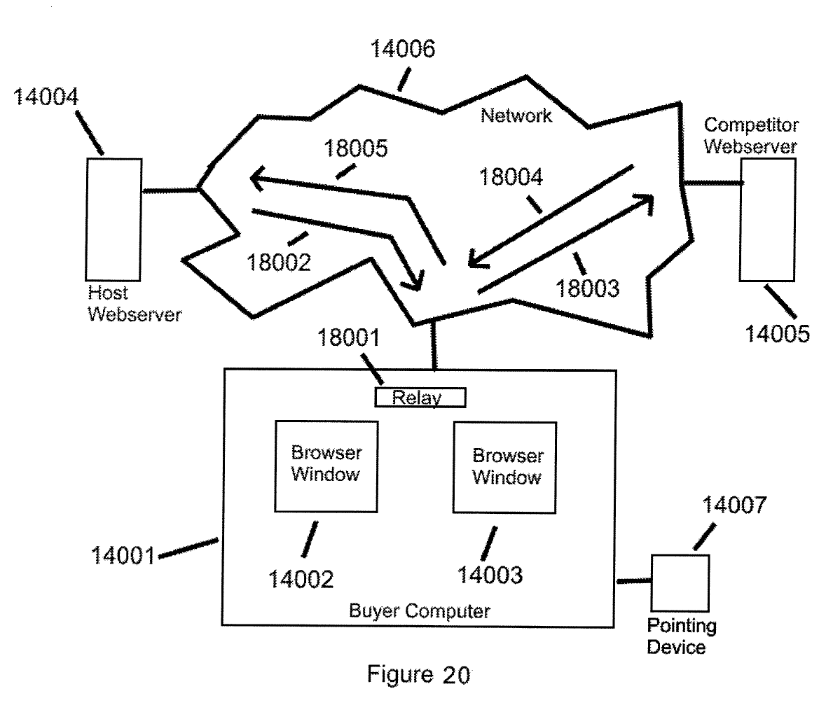

A competitor retailer can configure their competitor webserver 14005 to ignore requests from the host retailer webserver 14004. To avoid this problem, an alternate embodiment of the invention shown in FIG. 20 could be used. This alternative embodiment includes a relay 18001 installed on the buyer's computer 14001. Preferably, the relay 18001 is a small software application that the buyer could quickly and easily download from the host retailer webserver 14004 and install on the buyer computer 14001. With the relay 18001 installed, the host retailer webserver 14004 makes a request 18002 to the relay 18001 which sends a follow-on request 18003 to the competitor webserver 14005. The competitor webserver 14005 responds and sends a reply 18004 to the relay 18001 which send a follow-on reply 18005 to the host retailer webserver 14004. This embodiment enables the host retailer webserver 14004 to mask it's identity by allowing the competitor webserver 14005 “to think” it is communicating with the buyer.

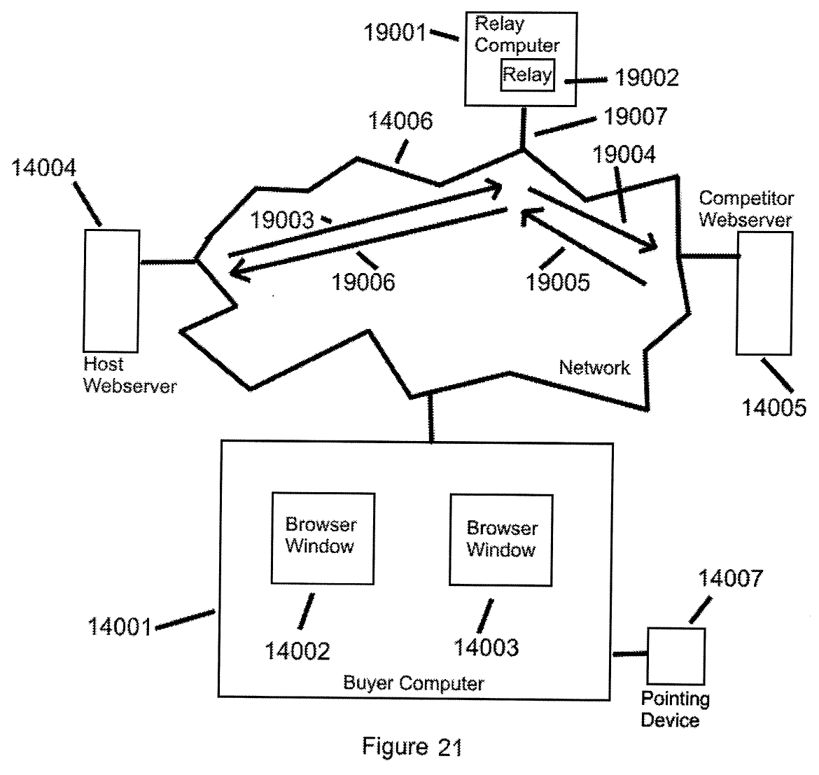

In another embodiment of the invention shown in FIG. 21, a relay 19002 is installed on a relay computer 19001 connected to the network 14006 via a connection 19007. The host webserver 14004 makes a request 19003 to the relay 19002 which sends a follow-on request 19004 to the competitor webserver 14005. The competitor webserver 14005 responds and sends a reply 19005 to the relay 19002 which sends a follow-on reply 19006 to the host webserver 14004. This embodiment enables the host webserver 14004 to mask it's identity by allowing the competitor webserver 14005 “to think” it is communicating with another potential buyer. The connection 19007 preferably has a dynamic IP address that changes at predetermined times.

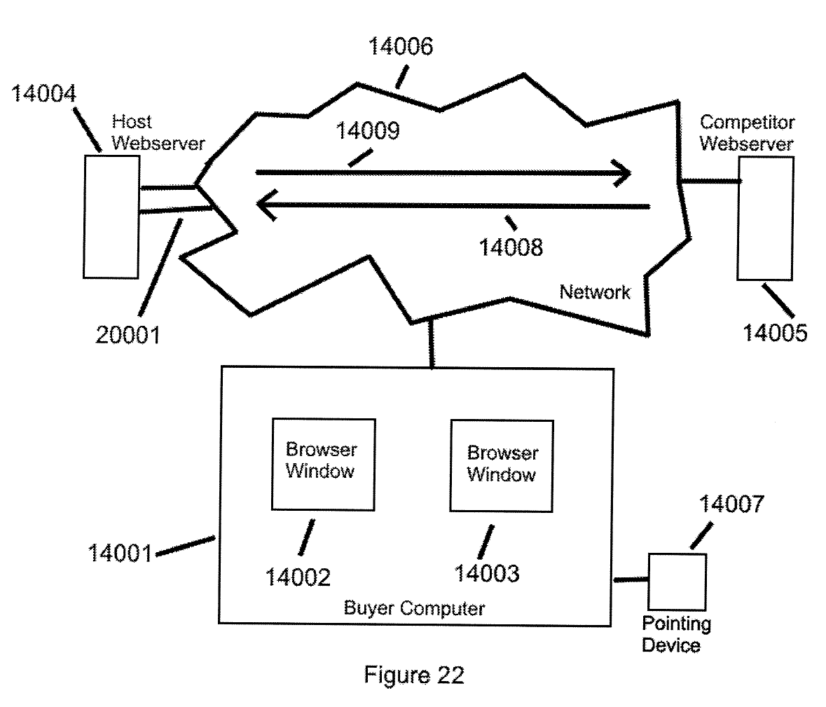

In another embodiment of the invention shown in FIG. 22, the host webserver 14004 has a second connection 20001 to the network 14006 preferably with a dynamic IP address that changes at predetermined times. The host webserver 14004 uses the connection 20001 to communicate with the competitor webserver 14005. This embodiment enables the host webserver 14004 to mask it's identity by allowing the competitor webserver 14005 “to think” it is communicating with another buyer.

In another embodiment of the invention, the buyer-entered price 2008 of Step 5 (FIG. 2) is not required and may be excluded from the input required on the data collection page 2000 (FIG. 5). The host webserver 14004 can be enabled to implement a parsing method that finds the competitor price 3001 in the webpage copy 11001 (FIG. 8) of the competitor item page 3000 (FIG. 6). The host webserver 14004 can then utilize the parsed product price in place of the user-entered price 2008.

In another embodiment of the invention, the host webserver 14004 includes a price-verifier parsing method added to Step 7 (FIG. 2) that responds to a predetermined format of competitor item page 3000 (FIG. 6). The price-verifier parsing method parses the page information to derive the item's price from the page and compares the parsed price to the buyer-entered price 2008. If a match is found, the host webserver 14004 proceeds to Step 8. This embodiment can decrease buyer fraud (the buyer deliberately entering an incorrect price) and buyer errors (the buyer accidentally entering an incorrect price).

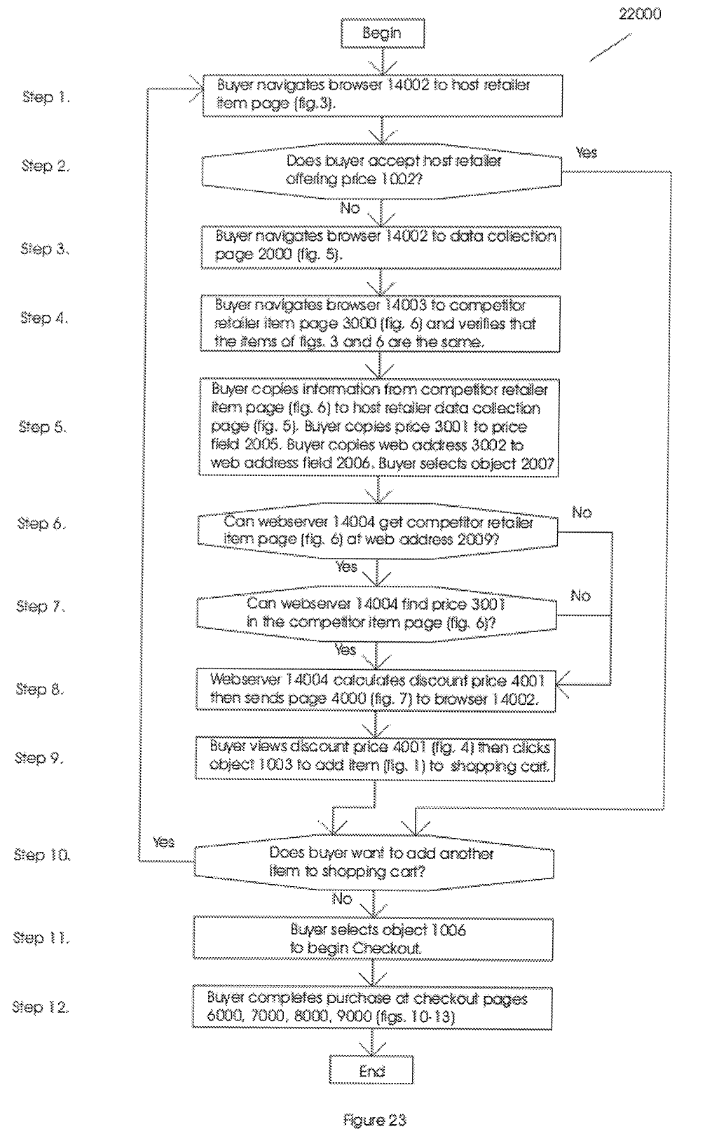

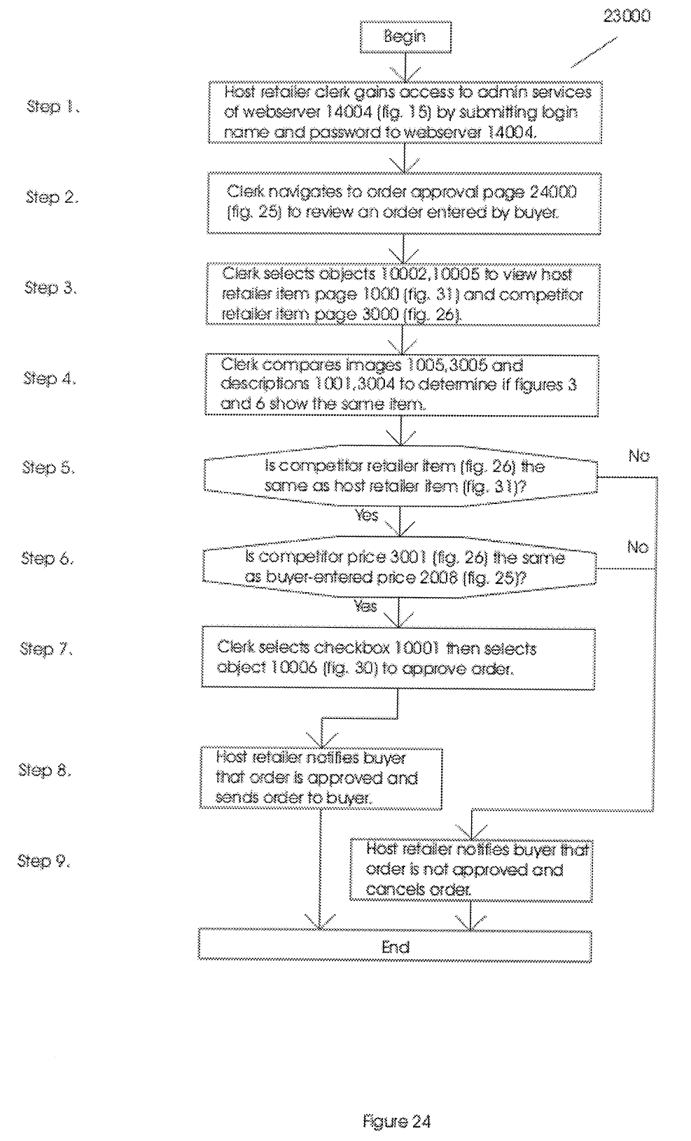

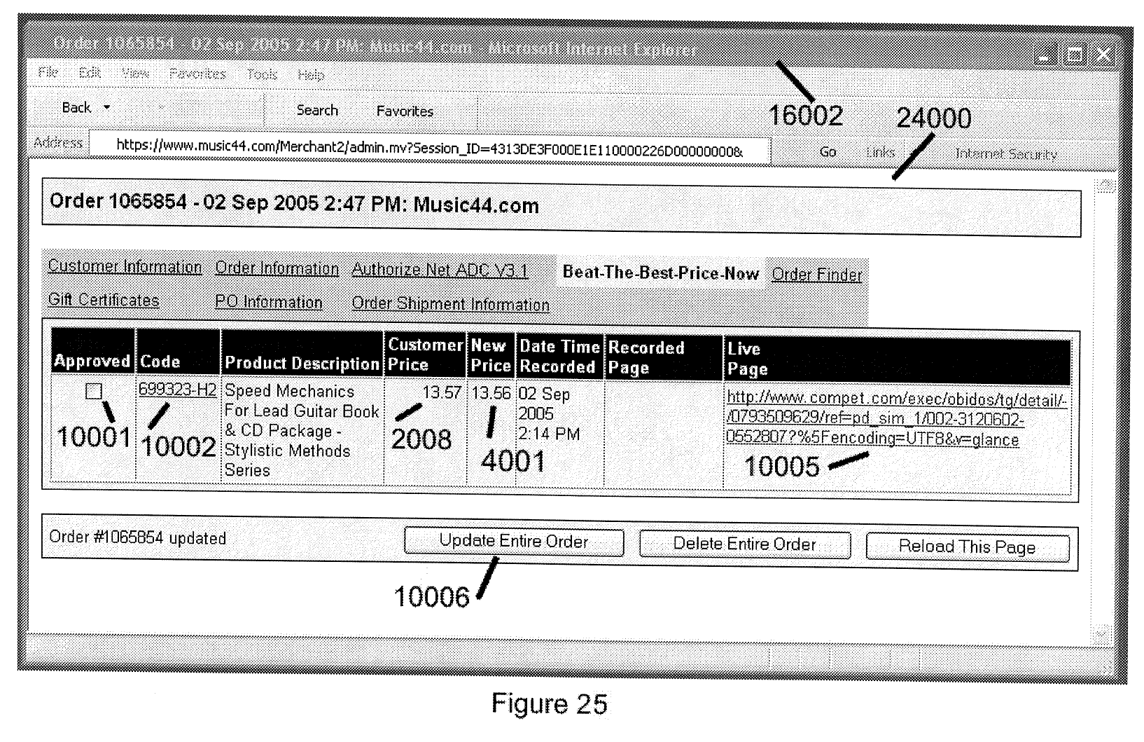

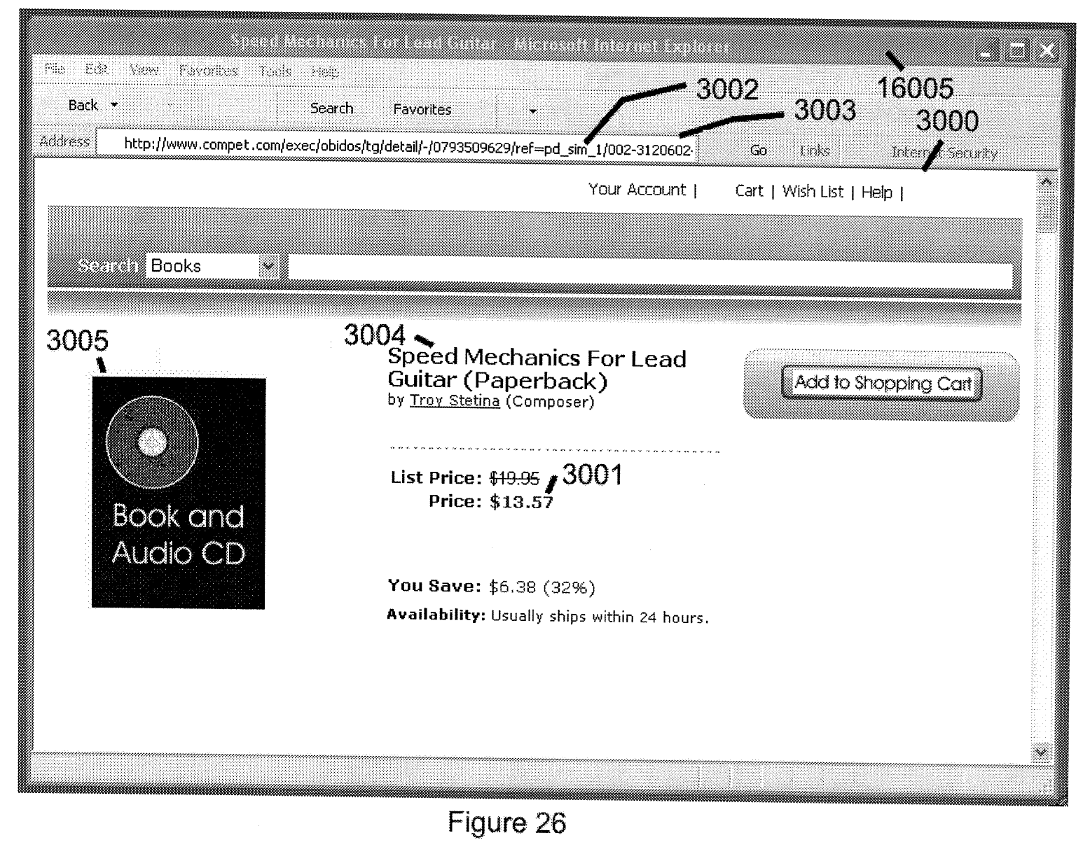

In another embodiment of the invention, an ordering method 22000 shown in FIG. 23 is used. The ordering method 22000 differs from the ordering method 15000 of FIG. 2 in that the branches at Steps 6 and 7 are disabled to decrease the time the buyer waits for the revised host retailer item page 4000 (FIG. 7) to be displayed in the browser window 14002; and to decrease the information processing load on the host webserver 14004. This arrangement can speed up other processes that could be occurring on the host webserver 14004 at the same time. In this embodiment, the buyer-entered price 2008 must be entered by the buyer if the “No” branches of Steps 6 or 7 are taken, or if the webserver 14004 does not parse the offering price 3001 from the webpage copy 11001. This embodiment uses an alternative order approval method 23000 shown in FIG. 24. The approval method 23000 differs from the order approval method 17000 of FIG. 16 at Steps 3-7. Since the host webserver 14004 might not have saved a webpage copy 11001 (FIG. 8) in the ordering method 22000, the clerk selects the competitor web address link 10005 (FIG. 25). The host webserver 14004 utilizes the buyer-entered web address 2009 to display the competitor item page 3000 (FIG. 26). The clerk compares the item pages of FIGS. 3 and 26 to approve or not approve the order.

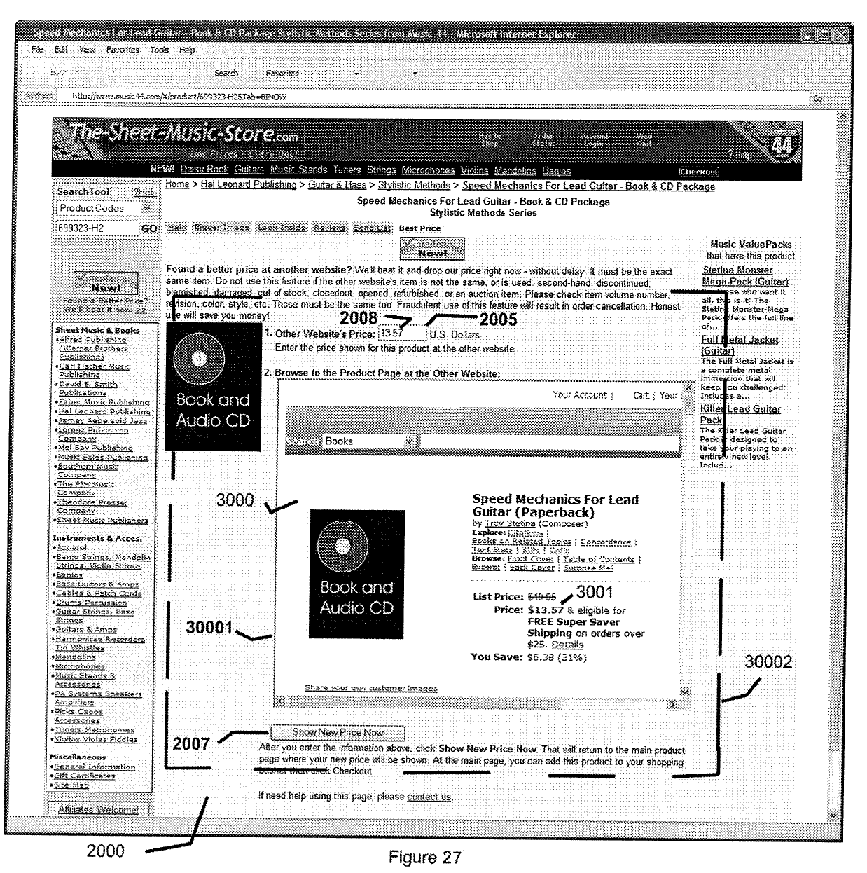

FIG. 27 shows another embodiment of the invention where the data collection page 2000 has an embedded web browser 30001 in place of the web address entry field 2006. In operation, the buyer navigates the embedded browser 30001 to the competitor item page 3000 and reads the competitor item price 3001. After determining that the competitor price 3001 is lower than the offering price 1002, the buyer enters the buyer-entered price 2008 into the price entry field 2005 then selects the “Show New Price” object 2007 in order to proceed to the host retailer revised item page 4000. Once there, the buyer can checkout and pay the discount item price 4001. This arrangement does not require any communication between the host retailer webserver 14004 and the competitor webserver 14005 because the embedded browser 30001 is included in a HTML form 30002 along with the “Show New Price” object 2007 and the price entry field 2005. When the buyer selects the “Show New Price” object 2007, the buyer's browser 14002 sends not only the buyer-entered price 2008 but also the HTML script of the competitor webpage shown in the embedded web browser 30001 to the host webserver 14004. Whether the competitor webserver 14005 is configured to ignore requests from the host webserver 14004 is irrelevant because the webservers do not communicate with each other directly.

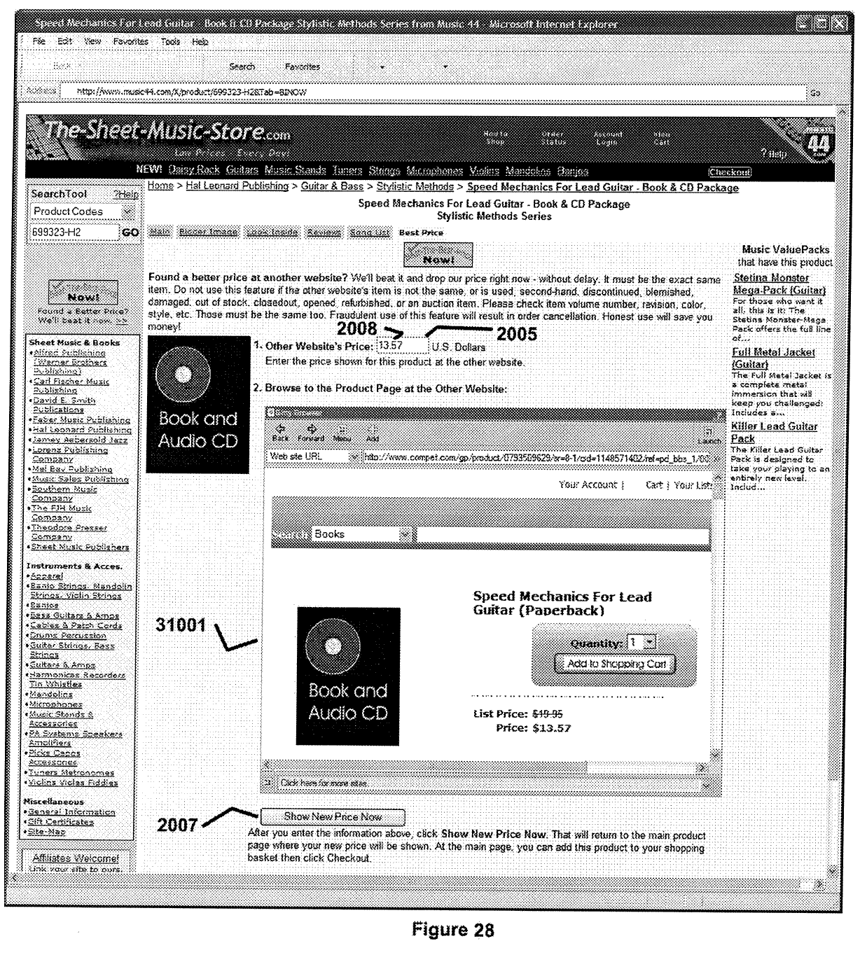

Embedded web browser 30001 can be an ActiveX WebBrowser component provided by Microsoft Corporation. Alternatively, FIG. 28 shows a Bitty Browser 31001 which is a JavaScript browser provided by Scott Matthews (http://www.bitty.com/). The Bitty Browser 31001 is embedded on the form 30002 instead of the browser 30001. Cross-site scripting is a computer security vulnerability typically found in web applications which can be used by an attacker to compromise a computer system (http://en.wikipedia.org/wiki/Cross_site_scripting). To prevent such an attack, many commercially available web browsers do not support cross-site scripting. Practical implementations of the alternative embodiments of FIGS. 27 and 28 are preferably configured to not rely on cross-site scripting for operation.

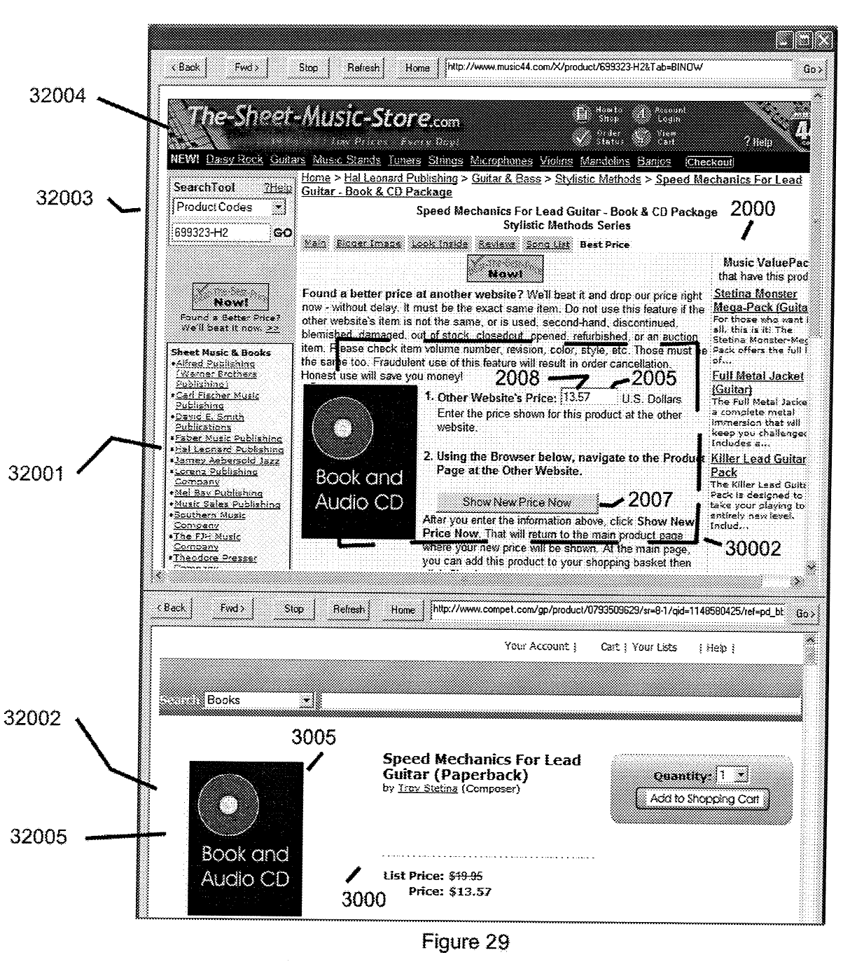

Another embodiment of the invention is shown in FIG. 29 where a dual-window browser 32003 displays two websites simultaneously. The dual-window browser 32003 can be implemented as an Active-X application written in Microsoft Visual Basic that runs inside a browser window. The application installation files can be delivered to the browser window 14002 on the buyer computer 14001 which installs the application automatically. In operation, the buyer navigates a first window 32004 to the host retailer data collection page 2000 and navigates a second window 32005 to the competitor item page 3000. The dual-window browser 32003 is configured to recognize this condition and copy the HTML script of the page shown in the second window 32005 to a hidden element of the form 30002. When the buyer selects the “Show New Price” object 2007, the dual-window browser 32003 sends the user-entered price 2008 and the HTML script to the host webserver 14004. Whether the competitor webserver 14005 is configured to ignore requests from the host webserver 14004 is irrelevant because the webservers do not communicate with each other directly. In another embodiment of the invention, the dual-window browser 32003 is configured to recognize competitor item page 3000, parse price 3001 from it, and insert price 3001 into the price entry field 2005 as the user-entered price 2008 in order to eliminate a step for the buyer.

In another embodiment of the invention, host webserver 14004 is configured to perform an additional operation at step 8 in FIG. 2. After calculating the discount price 4001, webserver 14004 changes the offering price 1002 of item 12 to the discount price 4001 by overwriting the numerical value of offering price 1002 with the numerical value of the discount price 4001 and saving that change to the products database 13 of webserver 14004. This changes the offering price 1002 of FIG. 3 to the discount price 4001 for all future buyers who use the host retailer website after the buyer places an order. Any future buyer can later reference a competitor website to change the offering price 1002 for himself/herself, place an order, and again change the offering price 1002 for all buyers who use the host retailer website after his/her order has been placed.

In another embodiment of the invention, host webserver 14004 is configured to perform an additional operation at step 8 in FIG. 16. After notifying the buyer of order approval, webserver 14004 changes the offering price 1002 of item 12 to the discount price 4001 by overwriting the numerical value of offering price 1002 with the numerical value of the discount price 4001 and saving that change to the products database 13 of webserver 14004. This changes the offering price 1002 of FIG. 3 to the discount price 4001 for all future buyers who use the host retailer website after the order is approved. Any future buyer can later reference a competitor website to change the offering price 1002 for himself/herself, place an order, and again change the offering price 1002 for all buyers who use the host retailer website after his/her order has been approved by the clerk.

In another embodiment of the invention, data collection page 2000 of FIG. 5 includes an additional data entry field and more instructions for the buyer. The instructions 2001 instruct the buyer to enter a competitor retailer's shipping cost 2012 for item 12′ into a shipping cost entry field 2011, which is added to page 2000. The discount price calculations of FIG. 19 include an additional step that calculates a numerical shipping cost difference 19010 by subtracting the competitor retailer's shipping cost 2012 from a predetermined host retailer shipping cost 21006, which the host retailer defines and includes in the administrative discount setup page 21000 of FIG. 18. The shipping cost difference 19010 is subtracted from the discount price 4001 when the discount price 4001 is calculated by the host webserver 14004 at Step 8 of FIG. 2. When the shipping cost difference 19010 is greater than zero, it decreases the discount price 4001 in response to the host retailer's shipping cost being “more expensive” than the competitor retailer's shipping cost 2012. On the other hand, when the shipping cost difference 19010 is less than zero, it increases the discount price 4001 in response to the host retailer's shipping cost being “less expensive” than the competitor retailer's shipping cost 2012.

In other words, this embodiment enables the host retailer to automatically lower the discount price 4001 when the competitor retailer is offering a lower cost, subsidized or free, shipping cost; and automatically raise the discount price 4001 when the competitor retailer is offering a higher cost, excessive or inflated, shipping cost.

Some competitor retailers artificially inflate their shipping cost above the actual cost of shipping and make an offsetting decrease in there offering price. Other competitor retailers do the opposite. They discount their shipping cost below the actual cost of shipping (to at or near zero) and make an offsetting increase in their offering price. This embodiment of the invention enables the host retailer to readily compete and beat competitor retailers, regardless of whether they inflate or discount their shipping cost.

In another embodiment of the invention, the host webserver 14004 eliminates the buyer's step of entering the competitor retailer's shipping cost 2012 by parsing the shipping cost 2012 from the competitor webpage copy 11001 (FIG. 8). But since the shipping cost 2012 might not be available on webpage copy 11001, the host webserver 14004 is preconfigured to calculate a competitor retailer's estimated shipping cost 2012′, when the shipping cost 2012 can not be parsed.

Many competitor retailers post their shipping policy and shipping charge information on a designated page of their website. In this embodiment, personnel working for the host retailer acquire and review the shipping information, develop a formula to calculate the estimated competitor shipping costs and then configure the host webserver 14004 to respond to the competitor retailer's website address 2009 as entered by the buyer. When the competitor's website address 2009 is entered by the buyer, the host webserver 14004 uses the formula to calculate the estimated competitor shipping cost 2012′; and automatically inserts the estimated cost shipping 2012′ into the shipping cost entry field 2011 in order to eliminate the step for the buyer.

In another embodiment of the invention, the shipping cost difference 19010 is subtracted from the shipping costs in the shipment method selection table 7001 of FIG. 11, instead of being subtracted from the discount price 4001. For example, if the shipping cost difference 19010 is $1.00, then the cost of Media Mail becomes $2.88 instead of $3.88, Preferred Mail becomes $4.59 instead of $4.59, and Parcel Post becomes $5.40 instead of $6.40, etc.

In another embodiment of the invention, the discount price 4001 is not displayed explicitly on any host webpage, such as the revised item page 4000 of FIG. 7; or on the buyer's shopping call page 13001, such as the page shown in FIG. 4. Instead, the discount price 4001 is implied by showing offering price 1002 accompanied by an additional discount 4007, where the additional discount 4007 is computed by the host webserver 14004 as the numerical difference between the offering price 1002 and the discount price 4001. The additional discount 4007 can be so-called a rebate, a refund, a reimbursement, a factor, a credit, an accumulation of points or another term.

Some host retailers are required by their suppliers to follow a minimum advertised price policy (MAP pricing guideline) in which the supplier sets a minimum offering price 1002 that the host retailer can display on its website for a given item. In order to comply with the MAP pricing guideline, the host webserver 14004 can show the offering price 1002 accompanied by the additional discount 4007. Alternatively, the host webserver 14004 can sum the additional discount 4007 for each item purchased by the buyer and show a summary discount 4009 on the shopping cart page 13001 and the checkout pages, such as the pages of FIGS. 10-13 for example.

The host retailer can attribute the summary discount 4009 to the buyer in any of various formats, such as (but not limited to), cash; cash equivalents including a credit card refund, a bank draft, a bank account deposit; or non-cash equivalents including redeemable points, credits, coupons, gift certificates, or other instruments that can be redeemed by the buyer for goods or services. The host retailer can give the buyer the option of selecting a discount format, and provide different amounts for the different discount formats. For example, the host retailer may offer the discount to the buyer as a larger amount for a gift certificate than for cash because the gift certificate will encourage the buyer to purchase further items from the host retailer's website.

While the present system is susceptible to various modifications and alternative forms, exemplary embodiments thereof have been shown by way of example in the drawings and are herein described in detail. It should be understood, however, that there is no intent to limit the system to the particular forms disclosed, but on the contrary, the intention is to address all modifications, equivalents, and alternatives falling within the spirit and scope of the system as defined by the appended claims.

I claim:

1. An on-line price discounting method that enables a host retailer to sell an item at different prices to different buyers, the method comprising:
offering the item for sale on a host site, the item having a host item description and a host offering price;
providing a buyer with an option of lowering the host offering price based on information for the item from a competitor site;
accepting buyer-provided information regarding the item from the competitor site;
calculating a discount price for the item using the buyer-provided information;
presenting the buyer with the discount price for the item; and
enabling the buyer to place an order for the item at the discount price.

2. The method of claim 1, wherein the accepting buyer-provided information step comprises:
providing the buyer with a data collection page, the data collection page including at least one field for entry of the buyer-provided information;
accepting the buyer-provided information through the data collection page.

3. The method of claim 2, wherein the data collection page includes a price field for entry of a buyer-entered price and an address field for entry of a competitor item webpage address.

4. The method of claim 2, wherein the data collection page includes an address field for entry of a competitor item webpage address, the method further comprising:
requesting a copy of a competitor item page using the competitor item webpage address;
storing a webpage copy of the competitor item page.

5. The method of claim 2, wherein the data collection page includes an embedded web browser, the method further comprising:
enabling the buyer to navigate the embedded web browser to a competitor item page.

6. The method of claim 5, further comprising:
parsing the competitor item page to find a parsed competitor price.

7. The method of claim 6, wherein the data collection page includes a price field for entry of a buyer-entered price, the method further comprising:
comparing the buyer-entered price to the parsed competitor price;
taking a non-approval action if the buyer-entered price does not equal the parsed competitor price.

8. The method of claim 1, wherein the buyer-provided information includes a buyer-entered price for the item and buyer-entered webpage information regarding a competitor item page containing competitor information concerning the item, the method further comprising:
accessing the competitor item page using the buyer-entered webpage information;
obtaining a competitor price for the item from the competitor item page;
comparing the competitor price to the buyer-entered price;
taking a non-approval action if the buyer-entered price does not equal the competitor price.

9. The method of claim 1, wherein the buyer-provided information includes a buyer-entered webpage address, the buyer entered webpage address allegedly being for a competitor item page containing competitor information concerning the item, the method further comprising:
attempting to access the competitor item page using the buyer-entered webpage address;
taking a non-approval action if the buyer-entered webpage address does not provide access to the competitor item page.

10. The method of claim 1, wherein the host item description includes a host item code, the host item code uniquely identifying the item, the method further comprising:
creating a discount database containing a plurality of discount records, each discount record being for a unique buyer;
and the step of presenting the buyer with the discount price comprises:
searching the discount database for a buyer discount record for the buyer, and creating a buyer discount record for the buyer if none is found, the buyer discount record being one of the plurality of discount records;
storing the host item code in the buyer discount record; and
storing the discount price in the buyer discount record; and
displaying the discount price to the buyer.

11. The method of claim 10, wherein whenever a current item price for the item is presented to the buyer, the current item price including the offering price and the discount price, the method further comprises:
checking the discount database for a stored discount record for the buyer, the stored discount record containing a stored item code and a stored discount price;
if the stored discount record for the buyer is found, checking the stored discount record for the host item code of the item;
if the host item code is found in the stored discount record for the buyer, retrieving the stored discount price for the host item code; and
displaying the stored discount price for the host item code as the current item price.

12. The method of claim 1, wherein the buyer provided information includes a buyer-entered price for the item and competitor information for the item, and wherein after the buyer has placed the order, the method further comprises;
viewing the host item description;
using the competitor information to view a competitor item description and a competitor price;
checking whether the competitor item description and the host item description describe the same items;
if the competitor and host item descriptions describe the same items, then checking whether the buyer-entered price and the competitor price are equal; and
if the competitor and host item descriptions describe the same items and the buyer-entered price and the competitor price are equal, then approving the order.

13. The method of claim 1, further comprising:
storing an administrative discount setup record containing discount parameters;
calculating the discount price using the discount parameters.

14. The method of claim 13, wherein the buyer provided information includes a competitor price; and the step of calculating a discount price comprises:
calculating a temporary price less than or equal to the competitor price;
calculating a minimum price based on the discount parameters;
if the minimum price is greater than the temporary price, setting the temporary price equal to the minimum price; and
comparing the temporary price with the host offering price; and
presenting the lesser of the temporary price and the host offering price as the discount price.

15. The method of claim 1, further comprising:
making arrangements to have requests from the host site for information on a competitor site not appear to originate from the host site.

16. The method of claim 15, wherein the step of making arrangements comprises:
enabling the buyer to download a relay to a buyer computer;
directing requests from the host site for requested information on the competitor site to the relay; and
receiving the requested information from the relay.

17. The method of claim 15, wherein the step of making arrangements comprises:
installing a relay on a relay computer;
directing requests from the host site for requested information on the competitor site to the relay; and
receiving the requested information from the relay.

18. The method of claim 15, wherein the step of making arrangements comprises:
installing a dynamic network connection at the host site having a dynamic IP address;
directing requests from the host site for requested information on the competitor site through the dynamic network connection; and
receiving the requested information through the dynamic network connection.

19. The method of claim 1, further comprising:
calculating a shipping cost difference; and
incorporating the shipping cost difference in the calculation of the discount price for the item.

20. The method of claim 1, wherein the step of calculating a discount price for the item includes calculating an additional discount to be deducted from the host offering price, the discount price being equal to the host offering price minus the additional discount; and
the step of presenting the buyer with the discount price for the item includes presenting the buyer with the additional discount.

21. The method of claim 20, wherein the additional discount is offered as a non-cash equivalent.

22. An on-line price discounting system that enables a host retailer to sell an item at different prices to different buyers, the system comprising:
a host webpage that offers the item for sale at a host offering price, the item having a host item description;
a price discounting option that enables a buyer to attempt to lower the host offering price based on information for the item from a competitor site;
a data collection module that collects buyer-provided information regarding the item from the competitor site;
a discount price calculation module that calculates a discount price for the item using the buyer-provided information; and
a host webpage revision module that offers the item for sale at the discount price.

23. The system of claim 22, wherein the data collection module comprises a data collection page, the data collection page including at least one field for entry of the buyer-provided information.

24. The system of claim 23, wherein the data collection page includes a price field for entry of a buyer-entered price and an address field for entry of a competitor item webpage address.

25. The system of claim 23, wherein the data collection page includes an address field for entry of a competitor item webpage address; and wherein the data collection module includes the functionality to request a copy of a competitor item page using the competitor item webpage address, and store a webpage copy of the competitor item page.

26. The system of claim 23, wherein the data collection page includes an embedded web browser; and wherein the data collection module includes the functionality to enable the buyer to navigate the embedded web browser to a competitor item page.

27. The system of claim 26, wherein the data collection module includes a parsing routine that parses the competitor item page to find a parsed competitor price.

28. The system of claim 27, wherein the data collection page includes a price field for entry of a buyer-entered price; and
wherein the data collection module includes the functionality to compare the buyer-entered price to the parsed competitor price, and take a non-approval action if the buyer-entered price does not equal the parsed competitor price.

29. The system of claim 22, wherein the buyer-provided information includes a buyer-entered price for the item and buyer-entered webpage information regarding a competitor item page containing competitor information concerning the item; and
wherein the data collection module includes the functionality to access the competitor item page using the buyer-entered webpage information, obtain a competitor price for the item from the competitor item page, compare the competitor price to the buyer-entered price, and take a non-approval action if the buyer-entered price does not equal the competitor price.

30. The system of claim 22, wherein the buyer-provided information includes a buyer-entered webpage address, the buyer entered webpage address allegedly being for a competitor item page containing competitor information concerning the item; and
wherein the data collection module includes the functionality to attempt to access the competitor item page using the buyer-entered webpage address, and take a non-approval action if the buyer-entered webpage address does not provide access to the competitor item page.

31. The system of claim 22, further comprising a discount database containing a plurality of discount records, each discount record being for a unique buyer;
wherein the host item description includes a host item code, the host item code uniquely identifying the item; and
wherein the host webpage revision module includes the functionality to search the discount database for a buyer discount record for the buyer and create a buyer discount record for the buyer if none is found, the buyer discount record being one of the plurality of discount records; store the host item code in the buyer discount record; and store the discount price in the buyer discount record.

32. The system of claim 31, wherein whenever a current item price for the item is presented to the buyer, the current item price including the offering price and the discount price, the host webpage revision module includes the functionality to check the discount database for a stored discount record for the buyer, the stored discount record containing a stored item code and a stored discount price;
if the stored discount record for the buyer is found, the host webpage revision module includes the functionality to check the stored discount record for the host item code of the item;
if the host item code is found in the stored discount record for the buyer, the host webpage revision module includes the functionality to retrieve the stored discount price for the host item code; and present the stored discount price for the host item code as the current item price.

33. The system of claim 22, wherein the buyer provided information includes a buyer-entered price for the item and competitor information for the item, and
the system further comprises a price approval module that retrieves a competitor item description and a competitor price using the competitor information; checks whether the competitor item description and the host item description describe the same items; checks whether the buyer-entered price and the competitor price are equal; and, when the competitor and host item descriptions describe the same items and the buyer-entered price and the competitor price are equal, approves the order.

34. The system of claim 22, further comprising an administrative discount setup record containing discount parameters; and
wherein the discount price calculation module includes the functionality to calculate the discount price using the discount parameters.

35. The system of claim 34, wherein the buyer provided information includes a competitor price; and
wherein the discount price calculation module includes the functionality to calculate a temporary price less than or equal to the competitor price; calculate a minimum price based on the discount parameters; set the temporary price equal to the minimum price when the minimum price is greater than the temporary price; and set the discount price equal to the lesser of the temporary price and the host offering price.

36. The system of claim 22, further comprising an arrangement that makes requests from the host site for information on a competitor site not appear to originate from the host site.

37. The system of claim 36, wherein the arrangement includes a relay on a buyer computer such that requests from the host site for requested information on the competitor site are sent to the relay, and the requested information on the competitor site is received from the relay.

38. The system of claim 36, wherein the arrangement includes a relay installed on a relay computer such that requests from the host site for requested information on the competitor site are sent to the relay, and the requested information on the competitor site is received from the relay.

39. The system of claim 36, wherein the arrangement includes a dynamic network connection at the host site having a dynamic IP address such that requests from the host site for requested information on the competitor site are sent through the dynamic network connection; and the requested information on the competitor site is received through the dynamic network connection.

40. The system of claim 22, wherein the discount price calculation module includes the functionality to calculate a shipping cost difference, and incorporate the shipping cost difference in the discount price calculation for the item.

41. The system of claim 22, wherein the discount price calculation module includes the functionality to calculate an additional discount to be deducted from the host offering price, the discount price being equal to the host offering price minus the additional discount; and
the host webpage revision module includes the functionality to present the buyer with the additional discount.

42. The system of claim 41, wherein the additional discount is offered as a non-cash equivalent.

43. A computer program product having executable instruction codes that implement an on-line price discounting system that enables a host retailer to sell an item on a host website to different buyers at different prices, the computer program product comprising:
a first set of instruction codes for offering a price discounting option that enables a buyer to attempt to lower a current price for the item at the host website based on information for the item from a competitor site;
a second set of instruction codes for collecting buyer-provided information from the buyer regarding the item from the competitor site;
a third set of instruction codes for calculating a discount price for the item using the buyer-provided information; and
a fourth set of instruction codes for revising the pricing information and replacing the current price with the discount price.

44. The computer program product of claim 43, wherein the second set of instruction codes for collecting buyer-provided information includes instruction codes for creating a data collection page, the data collection page including at least one field for entry of the buyer-provided information.

45. The computer program product of claim 44, wherein the data collection page includes a price field for entry of a buyer-entered price and an address field for entry of a competitor item webpage address.

46. The computer program product of claim 44, wherein the data collection page includes an address field for entry of a competitor item webpage address; and wherein the second set of instruction codes for collecting buyer-provided information includes instruction codes for requesting a copy of a competitor item page using the competitor item webpage address, and storing a webpage copy of the competitor item page.

47. The computer program product of claim 44, wherein the second set of instruction codes for collecting buyer-provided information includes an embedded web browser and instruction codes for enabling the buyer to navigate the embedded web browser to a competitor item page.

48. The computer program product of claim 47, wherein the second set of instruction codes for collecting buyer-provided information includes instruction codes for parsing the competitor item page to find a parsed competitor price.

49. The computer program product of claim 48, wherein the data collection page includes a price field for entry of a buyer-entered price; and
wherein the second set of instruction codes for collecting buyer-provided information includes instruction codes for comparing the buyer-entered price to the parsed competitor price, and taking a non-approval action if the buyer-entered price does not equal the parsed competitor price.

50. The computer program product of claim 43, wherein the buyer-provided information includes a buyer-entered price for the item and buyer-entered webpage information regarding a competitor item page containing competitor information concerning the item; and
wherein the second set of instruction codes for collecting buyer-provided information includes instruction codes for accessing the competitor item page using the buyer-entered webpage information, obtaining a competitor price for the item from the competitor item page, comparing the competitor price to the buyer-entered price, and taking a non-approval action if the buyer-entered price does not equal the competitor price.

51. The computer program product of claim 43, wherein the buyer-provided information includes a buyer-entered webpage address, the buyer entered webpage address allegedly being for a competitor item page containing competitor information concerning the item; and
wherein the second set of instruction codes for collecting buyer-provided information includes instruction codes for attempting to access the competitor item page using the buyer-entered webpage address, and taking a non-approval action if the buyer-entered webpage address does not provide access to the competitor item page.

52. The computer program product of claim 43, further comprising a discount database containing a plurality of discount records, each discount record being for a unique buyer;
wherein the host item description includes a host item code, the host item code uniquely identifying the item; and
wherein the fourth set of instruction codes for revising the pricing information includes instruction codes for searching the discount database for a buyer discount record for the buyer and creating a buyer discount record for the buyer if none is found, the buyer discount record being one of the plurality of discount records; storing the host item code in the buyer discount record; and storing the discount price in the buyer discount record.

53. The computer program product of claim 52, wherein the fourth set of instruction codes for revising the pricing information includes instruction codes such that, whenever any host item price for the item is presented to the buyer, the fourth set of instruction codes checks the discount database for a stored discount record for the buyer, the stored discount record containing a stored item code and a stored discount price;
if the stored discount record for the buyer is found, the fourth set of instruction codes checks the stored discount record for the host item code of the item;
if the host item code is found in the stored discount record for the buyer, the fourth set of instruction codes retrieves the stored discount price for the host item code; and presents the stored discount price for the host item code as the current item price.

54. The computer program product of claim 53, further comprising a fifth set of instruction codes for approving a buyer order including instruction codes for retrieving a competitor item description and a competitor price using competitor information; checking whether the competitor item description and the host item description describe the same items; checking whether a buyer-entered price and the competitor price are equal; and approving the order when the competitor and host item descriptions describe the same items and the buyer-entered price and the competitor price are equal; the buyer-entered price and the competitor information for the item being part of the buyer provided information.

55. The computer program product of claim 43, wherein the third set of instruction codes for calculating the discount price includes an administrative discount setup record containing discount parameters used for calculating the discount price.

56. The computer program product of claim 55, wherein the buyer provided information includes a competitor price; and
wherein the third set of instruction codes for calculating the discount price includes instruction codes for calculating a temporary price less than or equal to the competitor price; calculating a minimum price based on the discount parameters; setting the temporary price equal to the minimum price when the minimum price is greater than the temporary price; and setting the discount price equal to the lesser of the temporary price and the host offering price.

57. The computer program product of claim 43, further comprising a fifth set of instruction codes for making requests from the host site for information on a competitor site not appear to originate from the host site.

5258. The computer program product of claim 57, wherein the fifth set of instruction codes includes a relay on a buyer computer such that requests from the host site for requested information on the competitor site are sent to the relay, and the requested information on the competitor site is received from the relay.

59. The computer program product of claim 57, wherein the fifth set of instruction codes includes a relay installed on a relay computer such that requests from the host site for requested information on the competitor site are sent to the relay, and the requested information on the competitor site is received from the relay.

60. The computer program product of claim 57, wherein the fifth set of instruction codes includes a dynamic network connection at the host site having a dynamic IP address such that requests from the host site for requested information on the competitor site are sent through the dynamic network connection; and the requested information on the competitor site is received through the dynamic network connection.

61. The computer program product of claim 43, wherein the third set of instruction codes for calculating the discount price includes instruction codes for calculating a shipping cost difference, and incorporating the shipping cost difference in the calculation of the discount price for the item.

62. The computer program product of claim 43, wherein the third set of instruction codes for calculating the discount price includes instruction codes for calculating an additional discount to be deducted from the host offering price, the discount price being equal to the host offering price minus the additional discount; and
wherein the fourth set of instruction codes for revising the pricing information includes instruction codes for presenting the buyer with the additional discount.

63. The computer program product of claim 62, wherein the additional discount is offered as a non-cash equivalent.
